(19) United States
(12) Patent Application Publication
(10) Pub. No.: US 2025/0223413 A1
(43) Pub. Date: Jul. 10, 2025

(54) URETHANE RESIN COMPOSITION

(71) Applicant: NIPPON AQUA CO., LTD., Tokyo (JP)

(72) Inventors: Shinichi EGAWA, Tokyo (JP); Takaki HATOMI, Tokyo (JP); Kazuhisa NAGATA, Tokyo (JP); Fumitaka NAKAMURA, Tokyo (JP)

(21) Appl. No.: 19/092,955

(22) Filed: Mar. 27, 2025

Related U.S. Application Data
(63) Continuation of application No. PCT/JP2023/035231, filed on Sep. 27, 2023.

(30) Foreign Application Priority Data
Sep. 28, 2022 (WO) PCT/JP2022/036113

(51) Int. Cl. C08J 9/12; C08K 3/32; C08K 3/34

(52) U.S. Cl. CPC C08J 9/125; C08K 3/32; C08K 3/346; C08J 2203/10; C08J 2207/04; C08J 2475/04; C08K 2003/323

(57) ABSTRACT

For achieving a predetermined flame retardancy, a urethane resin composition comprises a polyisocyanate compound, a polyol compound, a catalyst, a foaming agent, ammonium polyphosphate, and phosphoric ester, and is free from red phosphorus.

### CROSS REFERENCE TO RELATED APPLICATIONS

This is a continuation application of International Patent Application No. PCT/JP2023/035231 filed on Sep. 27, 2023 claiming priority upon International Patent Application No. PCT/JP2022/036113 filed on Sep. 28, 2022, of which full contents are incorporated herein by reference.

### BACKGROUND OF THE INVENTION

### Field of the Invention

The present invention relates to a urethane resin composition.

### Description of the Background Art

In reinforced concrete houses and steel frame houses, a thermal insulation material of sprayed hard urethane foam has often been used for the purpose of dew-condensation prevention, thermal insulation, and energy saving.

In recent years, there have been some rare cases of fire caused by the ignition of any thermal insulation materials due to any inappropriate construction management or the like. Even in the case of any general fire, fire is sometimes caught by any thermal insulation materials, causing the spread of fire.

In order to prevent a urethane foam from being burned, some fire-resistant coatings (inorganic spray materials such as cement-based materials) have been applied to the urethane foam. However, there have still been problems: it takes a long time to apply such coatings to the urethane foam; the coatings that adhere insufficiently to the urethane foam after application fall off from the urethane foam; and the like.

Urethane resin compositions described in the following Patent Documents 1 and 2 are known as urethane resin compositions imparted with flame retardancy.

### PRIOR ART DOCUMENTS

### Patent Documents

Patent Document 1: Japanese Patent No. 6200435
Patent Document 2: Japanese Patent No. 6725606

### Problems to be Solved

The urethane resin composition described in Patent Documents 1 and 2 contains red phosphorus as a flame retardant at a relatively high cost, and for this reason, it has reached a limit of cost reduction.

Further, the sprayed hard urethane foam had some opportunities to be used in the so-called “exposed” state where it had been finished as having a foam surface left within sight from the viewpoints of design and cost-saving. In such a red phosphorus containing foam body taking on a red hue had a lower degree of freedom in coloring, which has been problematic.

### SUMMARY OF THE INVENTION

In view of the foregoing, one of the objectives to be achieved by the present invention is to provide a urethane resin composition having a predetermined flame retardancy even without containing any red phosphorus.

### Means for Solving Problems

In order to solve the above-described problem, a first aspect of the present invention is a urethane resin composition comprising: a polyisocyanate compound, a polyol compound, a catalyst, a foaming agent, ammonium polyphosphate, and phosphoric ester, the urethane resin composition being free from red phosphorus.

The state of “being free from red phosphorus” with respect to the urethane resin composition according to the present invention does not exclude a state where the urethane resin composition contains merely a very small amount of red phosphorus as unavoidable impurity but is, preferably, equal to a state where the urethane resin composition does not contain any red phosphorus to such an extent that the foam body obtained through the urethane resin composition does not take on any hue.

According to the above-described composition features, there can be achieved a predetermined flame retardancy while avoiding any influence with respect to an increase in cost and restrictions on coloring caused by the addition of red phosphorus.

Further, the ammonium polyphosphate and the phosphoric ester may be set in amount per 100 parts by weight of the polyol compound, respectively, in any one of the following ranges.

### Range (A) of Amount

Ammonium polyphosphate/parts by weight: 20 or more and 75 or less
Phosphoric ester/parts by weight: 40 or more and 80 or less

### Range (B) of Amount

Ammonium polyphosphate/parts by weight: 20 or more and 100 or less
Phosphoric ester/parts by weight: 60 or more and 80 or less

### Range (C) of Amount

Ammonium polyphosphate/parts by weight: 40 or more and 75 or less
Phosphoric ester/parts by weight: 40 or more and 140 or less

### Range (D) of Amount

Ammonium polyphosphate/parts by weight: 40 or more and 100 or less
Phosphoric ester/parts by weight: 60 or more and 140 or less

### Range (E) of Amount

Ammonium polyphosphate/parts by weight: 40 or more and 125 or less
Phosphoric ester/parts by weight: 140

According to the above-described composition features, there can be achieved the urethane resin component equivalent to a quasi-uninflammable material defined in a heat release test in conformity with ISO-5660.

Still further, the ammonium polyphosphate and the phosphoric ester may be set in amount per 100 parts by weight of the polyol compound, respectively, in any one of the following ranges.

### Range (F) of Amount

Ammonium polyphosphate/parts by weight: 20 or more and 75 or less
Phosphoric ester/parts by weight: 40 or more and 80 or less

### Range (G) of Amount

Ammonium polyphosphate/parts by weight: 40 or more and 75 or less
Phosphoric ester/parts by weight: 40 or more and 120 or less

### Range (H) of Amount

Ammonium polyphosphate/parts by weight: 40 or more and 100 or less
Phosphoric ester/parts by weight: 60 or more and 120 or less

### Range (I) of Amount

Ammonium polyphosphate/parts by weight: 75 or more and 100 or less
Phosphoric ester/parts by weight: 60 or more and 140 or less

According to the above-described composition features, there can be achieved the urethane resin component equivalent to an uninflammable material defined in a heat release test in conformity with ISO-5660.

### Advantageous Effects of the Invention

According to the present invention, there can be achieved a urethane resin composition having a predetermined flame retardancy even without containing any red phosphorus.

### BRIEF DESCRIPTIONS OF THE DRAWINGS

FIG. 1 depicts a view of photographs for comparison in foam body hue among Experimental EXAMPLES 53, 54.

FIG. 2 depicts a view of photographs for comparison in foam body hue among Experimental EXAMPLES 55 to 57.

### DESCRIPTIONS OF EMBODIMENTS OF THE INVENTION

### <1> Entire Composition Of Components

A urethane resin composition according to an embodiment of the present invention is a composition for forming a foam body having a thermal insulation material for a building and at least including a polyisocyanate compound, a polyol compound, a catalyst, a foaming agent, and a flame retardant.

The urethane resin composition according to an embodiment of the present invention can include a mineral-derived material such as clay mineral.

A thermal insulation layer may be formed in a building, for example, by: a method in which a polyisocyanate compound (first liquid) and other components (second liquid) are separately prepared and the first and second liquids are mixed while being atomized, and then sprayed; or a method in which the first and second liquids are sprayed while being mixed together.

### <2> Properties

The urethane resin composition according to an embodiment of the present invention may have the following properties achieved by adjusting the formulation of materials.

### <2.1> Incombustibility (Non-Combustibility)

The urethane resin composition according to an embodiment of the present invention can serve as uninflammable material or as a quasi-uninflammable material in conformity with ISO-5660.

### <2.2> ISO-5660 Test

In a heat release test in conformity with ISO-5660, test equipment called a cone calorimeter is used.

The cone calorimeter includes a cone heater disposed above a specimen cut into a predetermine size, and a spark rod provided between the specimen and the cone heater. The specimen is heated by the cone heater to produce a flammable gas, and the flammable gas is ignited by sparks from the spark rod to cause combustion. The gross calorific value or the like obtained from the combustion is measured by a predetermined measuring method so that the flame retardancy is evaluated in light of the performance requirements shown in Table 1 below.

TABLE 1

| Type | Performance requirements |
|---|---|
| Uninflammable | (1) Gross calorific value is 8 MJ/m² or less for 20 min |
| material | after heat starts. |
| | (2) There is no crack or through-hole up to rear surface |
| | harmful to fire prevention for 20 min after heat starts. |
| | (3) Heat release rate does not consecutively exceed |
| | 200 kW/m² for duration of time exceeding 10 sec for |
| | 20 min after heat starts. |
| Quasi- | (1) Gross calorific value is 8 MJ/m² or less for 10 min |
| uninflammable | after heat starts. |
| material | (2) There is no crack or through-hole up to rear surface |
| | harmful to fire prevention for 10 min after heat starts. |
| | (3) Heat release rate does not consecutively exceed |
| | 200 kW/m² for duration of time exceeding 10 sec for |
| | 10 min after heat starts. |
| Flame-retardant | (1) Gross calorific value is 8 MJ/m² or less for 5 min |
| material | after heat starts. |
| | (2) There is no crack or through-hole up to rear surface |
| | harmful to fire prevention for 5 min after heat starts. |
| | (3) Heat release rate does not consecutively exceed |
| | 200 kW/m² for duration of time exceeding 10 sec for |
| | 5 min after heat starts. |

Japan Testing Center for Construction Material Fire resistance qualification test-evaluation operation method report Excerpt-version from “Fire resistance qualification evaluation” stipulated on: Jun. 1, 2000 (Hei-12); latest updated on: Jul. 1, 2021 https://www.jtccm.or.jp/Portals/0/resources/library/jtccm/seino/siryo/bassui/boukazairy ou.pdf

### <2.3> Density

The foam body of the urethane resin composition according to an embodiment of the present invention can have a density of 30 kg/m³ or more.

When the foam body has a density of 30 kg/m³ or more, the effect of sufficiently suppressing deformation against external impact can be obtained when used as a thermal insulation material for a building.

### <3> Polyisocyanate Compound

The polyisocyanate compound is a material to be used as a main agent in the urethane resin composition according to an embodiment of the present invention.

Examples of the polyisocyanate compound include aromatic polyisocyanate, alicyclic polyisocyanate, aliphatic polyisocyanate, modified polyisocyanate, and the like.

Examples of the aromatic polyisocyanate include phenylene diisocyanate, tolylene diisocyanate, xylylene diisocyanate, diphenylmethane diisocyanate, dimethyldiphenylmethane diisocyanate, triphenylmethane triisocyanate, naphthalene diisocyanate, polymethylene polyphenyl polyisocyanate, and the like.

Examples of the alicyclic polyisocyanate include cyclohexylene diisocyanate, methylcyclohexylene diisocyanate, isophorone diisocyanate, dicyclohexylmethane diisocyanate, dimethyldicyclohexylmethane diisocyanate, and the like.

Examples of the aliphatic polyisocyanate include methylene diisocyanate, ethylene diisocyanate, propylene diisocyanate, tetramethylene diisocyanate, hexamethylene diisocyanate, and the like.

Examples of the modified polyisocyanate include isocyanate-terminated prepolymers in which a polyol component is reacted with a polyisocyanate compound. Examples include urethane modified products, carbodiimide modified products, urea modified products, biuret modified products, and allophanate modified products.

The polyisocyanate compounds may be used alone or in combination of two or more.

Especially, polymethylene polyphenyl polyisocyanate (polymeric MDI, crude MDI) is preferred because it is liquid at room temperature and easily available.

Examples of the polymethylene polyphenyl polyisocyanate include Millionate MR-200, MR-100, and MR-400 available from Tosoh Corporation, Sumidur 44 V20L and Desmodur 44 V20L available from Covestro AG, PM-200 and PM-400 available from Wanhua Chemical Group Co., Ltd., and PAPI27 and PAPI135 available from Dow Inc.

It is preferable that the polyisocyanate is contained in the urethane resin composition in such an amount that the isocyanate index is 150 to 1000. When the isocyanate index is 150 or more, the flame retardancy is even better. When the isocyanate index is 1000 or less, the adhesion to a building structure or the like is good.

In particular, in an embodiment of the present invention, the isocyanate index is most preferably within a range of 400 to 800.

The isocyanate index is calculated as the equivalent ratio of isocyanate groups contained in the isocyanate component to active hydrogen contained in the polyol component, water of the foaming agent, and the like.

$$[ Isocyanate group ] / [ OH group ] ( mol ratio ) \times 100$$

### <4> Polyol Compound

The polyol compound is a material to be used as a curing agent in the urethane resin composition according to an embodiment of the present invention.

The polyol compound includes an ester-based polyol compound or an ether-based polyol compound, and a combination thereof.

### <4.1> Ester-Based Polyol Compound

Examples of the ester-based polyol compound include a polymer obtained by dehydration condensation of a polybasic acid and a polyhydric alcohol, a polymer obtained by ring-opening polymerization of lactone such as ε-caprolactone or α-methyl-ε-caprolactone, and a condensate of a hydroxycarboxylic acid and the polyhydric alcohol.

More specifically, examples of the polybasic acid include adipic acid, azelaic acid, sebacic acid, terephthalic acid, isophthalic acid, succinic acid, and the like. Terephthalic acid modification is preferred in terms of flame retardancy.

### <4.2> Other Polyol Compounds

Examples of other polyol compounds include polylactone polyol, polycarbonate polyol, aromatic polyol, alicyclic polyol, aliphatic polyol, polymer polyol, polyether polyol, and the like.

Examples of the polylactone polyol include polypropiolactone glycol, polycaprolactone glycol, polyvalerolactone glycol, and the like.

Examples of the polycarbonate polyol include polyols obtained by a dealcoholization reaction between: a hydroxyl group-containing compound such as ethylene glycol, propylene glycol, butanediol, pentanediol, hexanediol, octanediol, or nonanediol; and diethylene carbonate, dipropylene carbonate or the like.

Examples of the aromatic polyol include bisphenol A, bisphenol F, phenol novolac, cresol novolac, and the like.

Examples of the alicyclic polyol include cyclohexanediol, methylcyclohexanediol, isophoronediol, dicyclohexylmethanediol, dimethyldicyclohexylmethanediol, and the like.

Examples of the aliphatic polyol include ethylene glycol, propylene glycol, butanediol, pentanediol, hexanediol, and the like.

Examples of the polyfunctional polyether polyol include: low molecular weight polyols such as ethylene glycol, 1,2-propanediol, 1,3-propanediol, 1,2-butanediol, 1,3-butanediol, 1,4-butanediol, 1,5-pentanediol, 1,6-hexanediol, 1,8-octanediol, 1,9-nonanediol, 3-methyl-1,5-pentanediol, 3,3-dimethylolheptane, diethylene glycol, dipropylene glycol, neopentyl glycol, cyclohexane-1,4-diol, cyclohexane-1,4-dimethanol, dimer acid diol, bisphenol A, bis (B-hydroxyethyl)benzene, xylene glycol, glycerin, trimethylolpropane, pentaerythritol, and sucrose; or polyether polyols obtained by addition polymerization of alkylene oxides such as ethylene oxide, propylene oxide, butylene oxide, and the like with compounds having 2 or more, preferably 3 to 8 active hydrogen groups, as initiators having aromatic and aliphatic polyamines such as ethylenediamine, propylenediamine, toluene diamine, metaphenylenediamine, diphenylmethane diamine, xylylenediamine, triethanolamine; or polyether polyols obtained by ring-opening polymerization of alkyl glycidyl ethers such as methyl glycidyl ether, aryl glycidyl ethers such as phenyl glycidyl ether, and cyclic ether monomers such as tetrahydrofuran. In addition, polyether polyols containing bromine, phosphorus, and the like may be used.

### <5> Mineral-Derived Material

The mineral-derived material is a material for improving the flame retardancy and realizing a higher density.

A silicate compound is preferred as the mineral-derived material. For example, montmorillonite, saponite, hectorite, vermiculite, kaolinite, mica, talc, and the like may be used as the mineral-derived material.

An example including the kaolinite as a main component is kaolin.

The kaolin includes fired kaolin obtained by subjecting kaolin to high temperature treatment. The fired kaolin is preferred in that it has a low water content and a small particle diameter distribution.

The amount of the mineral-derived material is preferably, but not limited to, 3 to 85 parts by weight per 100 parts by weight of the polyol compound.

### <6> Catalyst

The catalyst to be used to form a urethane foam is a material for promoting a reaction between isocyanate and active hydrogen in polyol and a reaction between isocyanate and water.

Hereinafter, an example of the catalyst will be explained.

### <6.1> Trimerization Catalyst

The trimerization catalyst is a material for causing a reaction to occur among isocyanate groups included in the polyisocyanate compounds so as to trimerize the isocyanate groups thereby promoting the formation of an isocyanurate ring.

For such a trimerization catalyst, for example, nitrogen-containing aromatic compounds such as tris (dimethylaminomethyl) phenol, 2,4-bis(dimethylaminomethyl) phenol, and 2,4,6-tris (dialkylaminoalkyl) hexahydro-S-triazine; carboxylic acid alkali metal salts such as potassium acetate, potassium 2-ethylhexanoate, and potassium octylate; and quaternary ammonium salts such as tetramethylammonium salt, tetraethylammonium salt, and tetraphenylammonium salt may be used as the catalyst.

A combination of carboxylic acid alkyl metal salts and quaternary ammonium salts is preferred in terms of adhesion and flame retardancy at low temperatures.

Examples of the trimerization catalyst include Toyocat-TRX, Toyocat-TRV, and Toyocat-TR20 available from Tosoh Corporation, DABCO TMR, DABCO TMR-2, DABCO TMR-7, DABCO K-15, UCAT 18X, and POLYCAT 46 available from Evonik, and KAOLIZER NO. 410 and KAOLIZER NO. 420 available from Kao Corporation.

The amount of the trimerization catalyst may be set appropriately within such a range that a predetermined flame retardancy can be obtained, and is preferably, but not limited to, 1 to 20 parts by weight per 100 parts by weight of the polyol compound. When the amount of the trimerization catalyst is 1 part by weight or more, the flame retardancy is even better. When the amount of the trimerization catalyst is 20 parts by weight or less, any inconvenience such as clogging in a mixing part of a spray gun because of too fast reaction can be prevented.

### <6.2> Other Catalysts

As other catalysts, there may be adopted catalyst having amino groups and catalyst containing organic metals.

Examples of catalysts having amino groups include N-alkyl polyalkylene polyamines such as triethylenediamine, N,N,N′,N″,N″″-pentamethyldiethylenetriamine, N,N,N′,N′-tetramethyl-1,6-hexanediamine, and N,N,N′,N′-tetramethylethylenediamine, N′-(2-hydroxyethyl)-N,N,N′-trimethylethylenediamine, 1-(2-dimethylaminoethyl)-4-methylpiperazine, 1,2-dimethylimidazole, 1-isobutyl-2-methylimidazole, N-methylmorpholine, N-ethylmorpholine, N,N-dimethylaminoethylmorpholine, dimethylcyclocyclohexylamine dimethylethanolamine, dimethylaminohexanol, dimethylaminoethoxyethanol, and diazabicycloundecene.

Product examples of the amine catalysts include TEDA-L33, TOYOCAT-ET, TOYOCAT-MR, TOYOCAT-TE, TOYOCAT-DT, TOYOCAT-NP, RX-5, RX-10, and TOYOCAT-DM70 available from Tosoh Corporation, DABCO 33LV, DABCO BL-19, DABCO BL-11, DABCO DMEA, DABCO T, DABCO N-MM, DABCO N-EM, DABCO XDM, DABCO NC-IM, POLYCAT 201, and POLYCAT 204 available from Evonik, and KAOLIZER NO. 1, KAOLIZER NO. 3, KAOLIZER NO. 10, KAOLIZER NO. 31, KAOLIZER NO. 21, KAOLIZER NO. 22, KAOLIZER NO. 25, KAOLIZER NO. 26, KAOLIZER NO. 120, KAOLIZER NO. 300, KAOLIZER NO. 350, and KAOLIZER NO. 390 available from Kao Corporation.

Further, examples of catalysts containing organometallics include bismuth octylate, lead octylate, tin (II) 2-ethylhexanoate, dibutyl bis [(1-oxooctyl)oxy] stannane, dibutyltin diacetate, and dibutyltin dilaurate.

Product examples of organometallic catalysts include BiCAT 8210 available from The Shepherd Chemical Company and the like.

These catalysts may be used alone or in combination of two or more.

### <7> Foaming Agent

The foaming agent is a material for promoting density reduction of a formed product, because gas is produced in the resin when the polyisocyanate compound (first liquid) and other components (second liquid) are mixed.

The foaming agent is, for example, water. Water reacts with Isocyanate reacts with to produce carbon dioxide, which is trapped in the foam body, thereby promoting density reduction of the formed product.

Other examples of the foaming agent include what is called physical foaming agents as listed below. The physical foaming agent is liquid at room temperature and is gasified in the resin due to a heat release reaction between isocyanate and polyol to promote density reduction of the formed product.

### [1] Hydrocarbon Compound

Propane, butane, pentane, hexane, heptane, cyclopropane, cyclobutane, cyclopentane, cyclohexane, cycloheptane, methyl formate, etc.

### [2] Chlorinated Aliphatic Hydrocarbon Compound

Dichloroethane, propylchloride, isopropylchloride, butylchloride, isobutylchloride, pentylchloride, isopentylchloride, etc.

### [3] Fluorine Compound

CHF₃, CH₂F₂, CH₃F, etc.

### [4] Hydrochlorofluorocarbon Compound

Trichlormonofluoromethane, trichlortrifluoroethane, dichloromonofluoroethane, (e.g., HCFC141b (1,1-dichloro-1-fluoroethane), HCFC22 (chlorodifluoromethane), HCFC142b (1-chloro-1,1-difluoroethane)), etc.

### [5] Hydrofluorocarbon

HFC-245fa available from Central Glass Co., Ltd. (1,1,1,3,3-pentafluoropropane), HFC-365mfc available from Honeywell International Inc. (1,1,1,3,3-pentafluorobutane), etc.

### [6] Hydrofluoroolefin

Solstice LBA available from Honeywell International Inc. (HFO-1233zd, (E)-1-chloro-3,3,3-trifluoropropene, Opteon 1100 available from The Chemours Company (HFO-1336mzz (Z), (Z)-1,1,1,4,4,4-hexafluoro-2-butene), Opteon 1150 available from The Chemours Company (HFO-1336mzz (E), (E)-1,1,1,4,4,4-hexafluoro-2-butene), Amorea 1224 yd available from AGC Inc. ((Z)-1-chloro-2,3,3,3-tetrafluoropropene), etc.

### [7] Organic Compound

Methyl formate, diisopropyl ether, etc.

As other examples of the foaming agent, nitrogen gas, oxygen gas, argon gas, carbon dioxide gas, and the like, which can be dispersed or dissolved in the polyol component or the isocyanate component, may be used.

The amount of the foaming agent is preferably, but not limited to, 1 part by weight to 100 parts by weight per 100 parts by weight of polyol. As the parts by weight of the foaming agent increase, the foam density decreases, but the dimension stability and the compression strength decrease simultaneously. The parts by weight of the foaming agent therefore may be set to match the density design.

In an embodiment of the present invention, the foaming agents may be used alone or in combination of two or more.

### <8> Flame Retardant

The flame retardant is a material for imparting flame retardancy to the urethane resin composition according to an embodiment of the present invention. For the flame retardant in an embodiment of the present invention, there are used ammonium polyphosphate and phosphoric ester are used; however, no red phosphorus is used.

The ammonium polyphosphate (APP) is a chain inorganic phosphate compound containing ammonium cations with a molecular formula as NH₄O(NH₄PO₃)ₙNH₄, where “n” denotes a degree of polymerization. The ammonium polyphosphate is such a compound in a tasteless and odorless white powdered form, and the compound of a high degree of polymerization, in particular, is in a crystalline form. A structural formula indicative of the molecular structure of the ammonium polyphosphate is shown below:

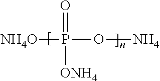

Product examples containing the ammonium polyphosphate include: Taien CII available from TAIHEI CHEMICAL INDUSTRIAL CO., LTD.; NNA21 available from Ameda Corporation; AP766, AP750, AP422 available from Clariant Japan Co. Ltd., and the like.

The Phosphoric ester (Organophosphate) is an ester obtained as a result of causing phosphoric acid and alcohol to undergo dehydration and condensation together out of organophosphorus compounds.

The phosphoric ester has a structure obtained as a result of substituting one or more organic groups for a part or the entirety of three atomic hydrogens (H) of a phosphoric acid (O═P(OH)₃). The esters on the order of 1, 2, 3 in a substitution number, there are called a phosphoric mono-ester, phosphoric di-ester, and phosphoric tri-ester, collectively called phosphoric ester. A structural formula indicative of the molecular structure of the phosphoric ester is shown below:

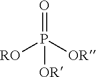

Product examples containing the phosphoric ester include tris (β-chloro-propyl) phosphate (TCPP) available from Wansheng, tri-cresyl phosphate (TCP) available from Zhangjiagang Fortune Chemical Co., Ltd., Tris (dimethyl-phenyl) phosphate (TXP) available from Zhangjiagang Fortune Chemical Co., Ltd., Triethyl phosphate (TEP) available from Wansheng, and the like.

### <9> Others

The urethane resin composition according to an embodiment of the present invention may contain other materials listed below as appropriate. For example, a composition containing at least one selected from the group consisting of foam stabilizer, surface conditioner, and compatibilizer may be a preferred embodiment of the urethane resin composition according to the present invention.

### <9.1> Foam Stabilizer

The foam stabilizer is, for example, an organosiloxane-polyoxyalkylene copolymer used in production of polyurethane foam.

Examples of the foam stabilizer include L-6900 available from Momentive and SH-193 available from Toray Dow Corning.

### <9.2> Surface Conditioner

The surface conditioner is an additive that serves as a defoaming agent, a leveling agent, and an anti-popping agent by controlling surface tension and forms a good coating. Examples of the surface conditioner include acrylic polymers such as SEI-W01 and SEI-1501 available from Kusumoto Chemicals, Ltd.

### <9.3> Compatibilizer

The compatibilizer is an element for suppressing phase separation.

There are some cases where liquid obtained as a result of mixing polyol, catalyst, foaming agent, aid, and the like, collectively called polyol premix, is frequently subjected to phase separation.

Due to the fact that the physical property of sprayed hard urethane foam using such a polyol premix subjected to the phase separation becomes worse, the compatibilizer suppresses such a worsening.

Examples of the compatibilizer includes polyoxyalkylene-alkylether, nonylphenol-ethoxylate, and the like.

### EXAMPLES

### <1> Test Materials

The following test was performed on a foam body made from the urethane resin composition according to an embodiment of the present invention. Details of each material are as follows.

### (1) Polyol Compound

A: Terephthalic acid polyester polyol (available from KAWASAKI KASEI CHEMICALS LTD. INC., product name: MAXIMOL RFK-509, hydroxyl value=200 mg KOH/g)

### (2) Catalyst

B1: Organometallic catalyst (available from The Shepherd Chemical Company, product name: BiCAT 8210)

### (3) Trimerization Catalyst

B2: Quaternary ammonium salt (available from Evonik, product name: TMR-7) B3: Potassium acetate catalyst (available from Evonik, product name: POLYCAT 46)

### (4) Flame Retardant

### [1] Ammonium Polyphosphate

C1: Ammonium polyphosphate (available from TAIHEI CHEMICAL INDUSTRIAL CO., LTD., product name: Taien CII) in a white powdered form containing phosphorus having an amount within a range of 29.0 to 34.0% and nitrogen having an amount within a range of 12.0 to 16.0%, whose degree of polymerization is 79.6.

C1-1: Ammonium polyphosphate (available from Ameda Corporation, product name: NNA21) in a white powdered form containing 31.6% (31% or more)-phosphorus and 14.3% (14% or more)-nitrogen, whose degree of polymerization is 1561 (1000 or more), where the number placed in the parenthesis denotes a specification value.

C1-2: Ammonium polyphosphate (available from Clariant Japan Co. Ltd., product name: AP766) in a white powdered form (no information).

C1-3: Ammonium polyphosphate (available from Clariant Japan Co. Ltd., product name: AP750) in a white powdered form containing 21%-phosphorus and 12%-nitrogen.

C1-4: Ammonium polyphosphate (available from Clariant Japan Co. Ltd., product name: AP422) in a white powdered form containing phosphorus having an amount within a range of 31.0 to 32.0% and nitrogen having an amount within a range of 14.0 to 15.0%.

### [2] Phosphoric Ester

C2: Phosphoric ester (available from Wansheng, product name: TCPP)

C2-1: Phosphoric ester (available from Wansheng, product name: TEP)

C2-2: Phosphoric ester (available from Zhangjiagang Fortune Chemical Co., Ltd., Product name: TXP)

C2-3: Phosphoric ester (available from Zhangjiagang Fortune Chemical Co., Ltd., Product name: TCP)

### (5) Foaming Agent

D1: HFO-1233zd (available from Honeywell International Inc., product name: Solstice LBA)

D2: HFO-1336mzz (available from The Chemours Company, product name: Opteon 1100)

D3: Water (hydroxyl value=6234 mg KOH/g)

### (6) Foam Stabilizer

E: Silicone foam stabilizer (available from Dow Tray Co. Ltd., product name: SH-193)

### (7) Surface Conditioner

F: Acrylic polymer (available from Kusumoto Chemicals, Ltd., product name: SEI-W01)

### (8) Compatibilizer

G1: Polyoxyalkylene-alkylether (available from Kao Corporation, product name: EMULGEN LS-106)

G2: Nonylphenol-ethoxylate (available from Dow Inc., product name: NP-9)

### (9) Mineral-Derived Material

H: Fired kaolin (available from IMERYS Minerals, product name: Glomax LL) white powdered form

### (10) Polyisocyanate

I: Polymeric MDI (available from Wanhua Chemical Group Co., Ltd. Corporation, product name: PM-200, NCO content=31%)

### <2> Specimen Preparation Method

In accordance with the formulations in the tables, every components such as polyol and the like were weighed and stirred in a 1000 mL polypropylene beaker.

Hereinafter, this stirred product is referred to as polyol premix.

The temperature of the polyol premix and isocyanate was regulated to 20° C.

The isocyanate component was added to the temperature-regulated polyol premix component in accordance with the formulations in the tables. The mixture was stirred with an electric mixer for about three seconds and then quickly poured into a 200×200×200 mm³ wood box having a temperature regulated to 20° C. to obtain a foam body. (The polyol premix component contained powder, which was dispersed by stirring in advance immediately before addition of the isocyanate component.)

The foam body cured for 24 hours after foaming was cut into a size of 99 mm×99 mm×50 mm, and the mass of the cut foam body was measured (the foam density was calculated from the obtained mass and the size). A cone calorimeter specimen was thus prepared. (This specimen was cut into a height of 50 mm relative to the foaming direction.)

### <3> Test Details

In a heat release test in conformity with the ISO-5660 test method, each specimen was heated at the intensity of radiant heat of 50 kW/m² for 20 minutes, and the gross calorific value (when heated for 10 minutes and heated for 20 minutes), the maximum heat release rate, the duration of time in which 200 kW/m² is exceeded (the duration of time in which the maximum heat release rate consecutively exceeds 200 kW/m²), and the like were evaluated.

Details of test equipment used in the present test are as follows.
Product name: cone calorimeter type: C4 available from Toyo Seiki Seisaku-sho, Ltd.
Distance between specimen and spark plug: 12.5 mm

### <4> Test Results

Experimental examples to be compared, which are extracted from all the test results, will be described with reference to the tables. It is to be noted that there was no crack or through-hole up to the rear surface harmful to the fire prevention in any specimens under the test.

### (1) Experimental Examples 1 and 2 (Table 2)

Initially, Table 2 shows Experimental EXAMPLES 1 and 2 in a case where only the ammonium polyphosphate is contained and a case where only the phosphoric ester is contained, as the flame retardant, respectively.

TABLE 2

| Product | | | OH value/ | EXAM- | EXAM- |
|---|---|---|---|---|---|
| name | Composition | | NCO content | PLE 1 | PLE 2 |
| MAXIMOL | A | Terephthalic acid | 200 | 100 | 100 |
| RFK-509 | | polyester polyol | | | |
| TMR-7 | B2 | Trimerization | | 5 | 5 |
| | | catalyst | | | |
| BiCAT | B1 | Catalyst | | 2 | 2 |
| 8210 | | | | | |
| POLYCAT | B3 | Trimerization | | 5 | 5 |
| 46 | | catalyst | | | |
| Taien CII | C1 | Flame retardant | | 0 | 50 |
| | | ammonium | | | |
| | | polyphosphate | | | |
| TCPP | C2 | Flame retardant | | 80 | 0 |
| | | phosphoric ester | | | |
| Solstice | D1 | Foaming agent | | 40 | 40 |
| LBA | | HFO-1233zd | | | |
| Opteon | D2 | Foaming agent | | 20 | 20 |
| 1100 | | HFO-1336mzz | | | |
| Water | D3 | Foaming agent | 6234 | 0.5 | 0.5 |
| (H₂O) | | water (H₂O) | | | |
| Polyol premix total | | | | 252.50 | 222.50 |
| PM-200 | I | Polyisocyanate | 31 | 252.50 | 222.50 |
| | | polymeric MDI | | | |

| | | |
|---|---|---|
| Polyol premix hydroxyl value | 91.55 | 103.90 |
| NCO Index | 452 | 399 |

| | | |
|---|---|---|
| CCM Result | EXAMPLE 1 | EXAMPLE 2 |

| | | | |
|---|---|---|---|
| Foam density | kg/m³ | 42.1 | 28.6 |
| Gross calorific | 10 min | Undetected | 23.4 |
| value | MJ/m² | | |
| | 20 min | Undetected | 26.3 |
| | MJ/m² | | |
| Maximum heat | kW/m² | Undetected | 126.1 |
| release rate | | | |

In Experimental EXAMPLE 1, cells (bubbles) had inhomogeneity in size within the specimen, which resulted in a quick determination that such a specimen is equivalent to neither uninflammable material nor quasi-uninflammable material, and for this reason, no heat release test was carried out.

Experimental EXAMPLE 2 resulted in the conclusion that the specimen is equivalent to neither uninflammable material nor quasi-uninflammable material.

### (2) Experimental Examples 3 to 45 (Tables 3 to 10)

Subsequently, there are shown Experimental EXAMPLES where the ammonium polyphosphate and the phosphoric ester were set in amount per 100 parts by weight of the polyol compound, respectively, in the following ranges.

[Ammonium polyphosphate/parts by weight]: 20, 40, 50, 75, 100, and 125
[Phosphoric ester/parts by weight]: 20, 40, 60, 80, 100, 120, and 140

Table 3 shows Experimental EXAMPLES dependent upon their respective amounts of the phosphoric ester within a range of 20 parts by weight to 140 parts by weight while the amount of the ammonium polyphosphate being fixed to be 20 parts by weight, per 100 parts by weight of the polyol compound.

In Experimental EXAMPLES 7 to 9 among them, each specimen having rough cells occurring therewithin was unsuitable as a thermal insulation material, no heat release test was carried out.

TABLE 3

| Product | | | OH value/ | EXAM- | EXAM- | EXAM- | EXAM- | EXAM- | EXAM- | EXAM- |
|---|---|---|---|---|---|---|---|---|---|---|
| name | Composition | | NCO content | PLE 3 | PLE 4 | PLE 5 | PLE 6 | PLE 7 | PLE 8 | PLE 9 |
| MAXIMOL | A | Terephthalic | 200 | 100 | 100 | 100 | 100 | 100 | 100 | 100 |
| RFK-509 | | acid polyester | | | | | | | | |
| | | polyol | | | | | | | | |
| TMR-7 | B2 | Trimerization | | 5 | 5 | 5 | 5 | 5 | 5 | 5 |
| | | catalyst | | | | | | | | |
| BiCAT | B1 | Catalyst | | 2 | 2 | 2 | 2 | 2 | 2 | 2 |
| 8210 | | | | | | | | | | |
| POLYCAT | B3 | Trimerization | | 5 | 5 | 5 | 5 | 5 | 5 | 5 |
| 46 | | catalyst | | | | | | | | |
| Taien CII | C1 | Flame retardant | | 20 | 20 | 20 | 20 | 20 | 20 | 20 |
| | | ammonium | | | | | | | | |
| | | polyphosphate | | | | | | | | |
| TCPP | C2 | Flame retardant | | 20 | 40 | 60 | 80 | 100 | 120 | 140 |
| | | phosphoric ester | | | | | | | | |
| Solstice | D1 | Foaming agent | | 40 | 40 | 40 | 40 | 40 | 40 | 40 |
| LBA | | HFO-1233zd | | | | | | | | |
| Opteon | D2 | Foaming agent | | 20 | 20 | 20 | 20 | 20 | 20 | 20 |
| 1100 | | HFO-1336mzz | | | | | | | | |
| Water | D3 | Foaming agent | 6234 | 0.5 | 0.5 | 0.5 | 0.5 | 0.5 | 0.5 | 0.5 |
| (H₂O) | | water (H₂O) | | | | | | | | |
| Polyol premix total | | | | 212.50 | 232.50 | 252.50 | 272.50 | 292.50 | 312.50 | 332.50 |
| PM-200 | I | Polyisocyanate | 31 | 212.50 | 232.50 | 252.50 | 272.50 | 292.50 | 312.50 | 332.50 |
| | | polymeric MDI | | | | | | | | |

| | | | | | | | |
|---|---|---|---|---|---|---|---|
| Polyol premix hydroxyl value | 108.79 | 99.43 | 91.55 | 84.83 | 79.03 | 73.97 | 69.52 |
| NCO Index | 381 | 417 | 452 | 488 | 524 | 560 | 596 |

| | | EXAM- | EXAM- | EXAM- | EXAM- | EXAM- | EXAM- | EXAM- |
|---|---|---|---|---|---|---|---|---|
| CCM Result | | PLE 3 | PLE 4 | PLE 5 | PLE 6 | PLE 7 | PLE 8 | PLE 9 |
| Foam density | kg/m³ | 23.6 | 26.5 | 26.9 | 29.7 | 38.0 | 44.8 | 43.7 |
| Gross calorific | 10 min | 9.4 | 4.5 | 4.0 | 5.1 | Undetected | Undetected | Undetected |
| value | MJ/m² | | | | | | | |
| | 20 min | 13.4 | 7.1 | 5.6 | 7.1 | Undetected | Undetected | Undetected |
| | MJ/m² | | | | | | | |
| Maximum heat | kW/m² | 73.1 | 55.4 | 53.3 | 54.8 | Undetected | Undetected | Undetected |
| release rate | | | | | | | | |

Table 4 shows Experimental EXAMPLES dependent upon their respective amounts of the phosphoric ester within a range of 20 parts by weight to 140 parts by weight while the amount of the ammonium polyphosphate being fixed to be 40 parts by weight, per 100 parts by weight of the polyol compound.

TABLE 4

| Product | | | OH value/ | EXAMPLE | EXAMPLE | EXAMPLE | EXAMPLE |
|---|---|---|---|---|---|---|---|
| name | Composition | | NCO content | 10 | 11 | 12 | 13 |
| MAXIMOL | A | Terephthalic acid | 200 | 100 | 100 | 100 | 100 |
| RFK-509 | | polyester polyol | | | | | |
| TMR-7 | B2 | Trimerization | | 5 | 5 | 5 | 5 |
| | | catalyst | | | | | |
| BiCAT | B1 | Catalyst | | 2 | 2 | 2 | 2 |
| 8210 | | | | | | | |
| POLYCAT | B3 | Trimerization | | 5 | 5 | 5 | 5 |
| 46 | | catalyst | | | | | |
| Taien CII | C1 | Flame retardant | | 40 | 40 | 40 | 40 |
| | | ammonium | | | | | |
| | | polyphosphate | | | | | |
| TCPP | C2 | Flame retardant | | 20 | 40 | 60 | 80 |
| | | phosphoric ester | | | | | |
| Solstice | D1 | Foaming agent | | 40 | 40 | 40 | 40 |
| LBA | | HFO-1233zd | | | | | |
| Opteon | D2 | Foaming agent | | 20 | 20 | 20 | 20 |
| 1100 | | HFO-1336mzz | | | | | |
| Water | D3 | Foaming agent | 6234 | 0.5 | 0.5 | 0.5 | 0.5 |
| (H₂O) | | water (H₂O) | | | | | |
| Polyol premix total | | | | 232.50 | 252.50 | 272.50 | 292.50 |
| PM-200 | I | Polyisocyanate | 31 | 232.50 | 252.50 | 272.50 | 292.50 |
| | | polymeric MDI | | | | | |

| | | | | |
|---|---|---|---|---|
| Polyol premix hydroxyl value | 99.43 | 91.55 | 84.83 | 79.03 |
| NCO Index | 417 | 452 | 488 | 524 |

| Product | | | OH value/ | EXAMPLE | EXAMPLE | EXAMPLE |
|---|---|---|---|---|---|---|
| name | Composition | | NCO content | 14 | 15 | 16 |
| MAXIMOL | A | Terephthalic acid | 200 | 100 | 100 | 100 |
| RFK-509 | | polyester polyol | | | | |
| TMR-7 | B2 | Trimerization | | 5 | 5 | 5 |
| | | catalyst | | | | |
| BiCAT | B1 | Catalyst | | 2 | 2 | 2 |
| 8210 | | | | | | |
| POLYCAT | B3 | Trimerization | | 5 | 5 | 5 |
| 46 | | catalyst | | | | |
| Taien CII | C1 | Flame retardant | | 40 | 40 | 40 |
| | | ammonium | | | | |
| | | polyphosphate | | | | |
| TCPP | C2 | Flame retardant | | 100 | 120 | 140 |
| | | phosphoric ester | | | | |
| Solstice | D1 | Foaming agent | | 40 | 40 | 40 |
| LBA | | HFO-1233zd | | | | |
| Opteon | D2 | Foaming agent | | 20 | 20 | 20 |
| 1100 | | HFO-1336mzz | | | | |
| Water | D3 | Foaming agent | 6234 | 0.5 | 0.5 | 0.5 |
| (H₂O) | | water (H₂O) | | | | |
| Polyol premix total | | | | 312.50 | 332.50 | 352.50 |
| PM-200 | I | Polyisocyanate | 31 | 312.50 | 332.50 | 352.50 |
| | | polymeric MDI | | | | |

| | | | |
|---|---|---|---|
| Polyol premix hydroxyl value | 73.97 | 69.52 | 65.58 |
| NCO Index | 560 | 596 | 632 |

| | | EXAMPLE | EXAMPLE | EXAMPLE | EXAMPLE | EXAMPLE | EXAMPLE | EXAMPLE |
|---|---|---|---|---|---|---|---|---|
| CCM Result | | 10 | 11 | 12 | 13 | 14 | 15 | 16 |
| Foam density | kg/m³ | 25.6 | 27.2 | 27.8 | 31.7 | 32.7 | 35.2 | 40.4 |
| Gross calorific | 10 min | 13.5 | 5.2 | 5.2 | 4.7 | 4.7 | 5.6 | 7.1 |
| value | MJ/m² | | | | | | | |
| | 20 min | 19.6 | 7.7 | 8.0 | 6.4 | 7.1 | 7.4 | 9.7 |
| | MJ/m² | | | | | | | |
| Maximum heat | kW/m² | 96.7 | 46.5 | 36.8 | 48.1 | 44.5 | 41.3 | 46.8 |
| release rate | | | | | | | | |

Table 5 shows Experimental EXAMPLES dependent upon their respective amounts of the phosphoric ester within a range of 20 parts by weight to 140 parts by weight while the amount of the ammonium polyphosphate being fixed to be 50 parts by weight, per 100 parts by weight of the polyol compound.

TABLE 5

| Product | | | OH value/ | EXAM- | EXAM- | EXAM- | EXAM- | EXAM- | EXAM- | EXAM- |
|---|---|---|---|---|---|---|---|---|---|---|
| name | Composition | | NCO content | PLE 17 | PLE 18 | PLE 19 | PLE 20 | PLE 21 | PLE 22 | PLE 23 |
| MAXIMOL | A | Terephthalic | 200 | 100 | 100 | 100 | 100 | 100 | 100 | 100 |
| RFK-509 | | acid polyester | | | | | | | | |
| | | polyol | | | | | | | | |
| TMR-7 | B2 | Trimerization | | 5 | 5 | 5 | 5 | 5 | 5 | 5 |
| | | catalyst | | | | | | | | |
| BiCAT | B1 | Catalyst | | 2 | 2 | 2 | 2 | 2 | 2 | 2 |
| 8210 | | | | | | | | | | |
| POLYCAT | B3 | Trimerization | | 5 | 5 | 5 | 5 | 5 | 5 | 5 |
| 46 | | catalyst | | | | | | | | |
| Taien CII | C1 | Flame retardant | | 50 | 50 | 50 | 50 | 50 | 50 | 50 |
| | | ammonium | | | | | | | | |
| | | polyphosphate | | | | | | | | |
| TCPP | C2 | Flame retardant | | 20 | 40 | 60 | 80 | 100 | 120 | 140 |
| | | phosphoric ester | | | | | | | | |
| Solstice | D1 | Foaming agent | | 40 | 40 | 40 | 40 | 40 | 40 | 40 |
| LBA | | HFO-1233zd | | | | | | | | |
| Opteon | D2 | Foaming agent | | 20 | 20 | 20 | 20 | 20 | 20 | 20 |
| 1100 | | HFO-1336mzz | | | | | | | | |
| Water | D3 | Foaming agent | 6234 | 0.5 | 0.5 | 0.5 | 0.5 | 0.5 | 0.5 | 0.5 |
| (H₂O) | | water (H₂O) | | | | | | | | |
| Polyol premix total | | | | 242.50 | 262.50 | 282.50 | 302.50 | 322.50 | 342.50 | 362.50 |
| PM-200 | I | Polyisocyanate | 31 | 242.50 | 262.50 | 282.50 | 302.50 | 322.50 | 342.50 | 362.50 |
| | | polymeric MDI | | | | | | | | |

| | | | | | | | |
|---|---|---|---|---|---|---|---|
| Polyol premix hydroxyl value | 95.33 | 88.06 | 81.83 | 76.42 | 71.68 | 67.49 | 63.77 |
| NCO Index | 434 | 470 | 506 | 542 | 578 | 614 | 649 |

| | | EXAM- | EXAM- | EXAM- | EXAM- | EXAM- | EXAM- | EXAM- |
|---|---|---|---|---|---|---|---|---|
| CCM Result | | PLE 17 | PLE 18 | PLE 19 | PLE 20 | PLE 21 | PLE 22 | PLE 23 |
| Foam density | kg/m³ | 27.2 | 28.6 | 29.8 | 33.9 | 35.2 | 38.2 | 38.4 |
| Gross calorific | 10 min | 16.4 | 4.9 | 4.1 | 4.6 | 5.8 | 4.9 | 6.9 |
| value | MJ/m² | | | | | | | |
| | 20 min | 22.4 | 7.4 | 5.3 | 6.2 | 8.0 | 6.4 | 11.7 |
| | MJ/m² | | | | | | | |
| Maximum heat | kW/m² | 103.1 | 48.1 | 43.0 | 26.6 | 47.9 | 44.9 | 49.5 |
| release rate | | | | | | | | |

Table 6 shows Experimental EXAMPLES dependent upon their respective amounts of the phosphoric ester within a range of 20 parts by weight to 140 parts by weight while the amount of the ammonium polyphosphate being fixed to be 75 parts by weight, per 100 parts by weight of the polyol compound.

TABLE 6

| Product | | | OH value/ | EXAM- | EXAM- | EXAM- | EXAM- | EXAM- | EXAM- | EXAM- |
|---|---|---|---|---|---|---|---|---|---|---|
| name | Composition | | NCO content | PLE 24 | PLE 25 | PLE 26 | PLE 27 | PLE 28 | PLE 29 | PLE 30 |
| MAXIMOL | A | Terephthalic | 200 | 100 | 100 | 100 | 100 | 100 | 100 | 100 |
| RFK-509 | | acid polyester | | | | | | | | |
| | | polyol | | | | | | | | |
| TMR-7 | B2 | Trimerization | | 5 | 5 | 5 | 5 | 5 | 5 | 5 |
| | | catalyst | | | | | | | | |
| BiCAT | B1 | Catalyst | | 2 | 2 | 2 | 2 | 2 | 2 | 2 |
| 8210 | | | | | | | | | | |
| POLYCAT | B3 | Trimerization | | 5 | 5 | 5 | 5 | 5 | 5 | 5 |
| 46 | | catalyst | | | | | | | | |
| Taien CII | C1 | Flame retardant | | 75 | 75 | 75 | 75 | 75 | 75 | 75 |
| | | ammonium | | | | | | | | |
| | | polyphosphate | | | | | | | | |
| TCPP | C2 | Flame retardant | | 20 | 40 | 60 | 80 | 100 | 120 | 140 |
| | | phosphoric ester | | | | | | | | |
| Solstice | D1 | Foaming agent | | 40 | 40 | 40 | 40 | 40 | 40 | 40 |
| LBA | | HFO-1233zd | | | | | | | | |
| Opteon | D2 | Foaming agent | | 20 | 20 | 20 | 20 | 20 | 20 | 20 |
| 1100 | | HFO-1336mzz | | | | | | | | |
| Water | D3 | Foaming agent | 6234 | 0.5 | 0.5 | 0.5 | 0.5 | 0.5 | 0.5 | 0.5 |
| (H₂O) | | water (H₂O) | | | | | | | | |
| Polyol premix total | | | | 267.50 | 287.50 | 307.50 | 327.50 | 347.50 | 367.50 | 387.50 |
| PM-200 | I | Polyisocyanate | 31 | 267.50 | 287.50 | 307.50 | 327.50 | 347.50 | 367.50 | 387.50 |
| | | polymeric MDI | | | | | | | | |

| | | | | | | | |
|---|---|---|---|---|---|---|---|
| Polyol premix hydroxyl value | 86.42 | 80.41 | 75.13 | 70.59 | 66.52 | 62.90 | 59.66 |
| NCO Index | 479 | 515 | 551 | 587 | 623 | 658 | 694 |

| | | EXAM- | EXAM- | EXAM- | EXAM- | EXAM- | EXAM- | EXAM- |
|---|---|---|---|---|---|---|---|---|
| CCM Result | | PLE 24 | PLE 25 | PLE 26 | PLE 27 | PLE 28 | PLE 29 | PLE 30 |
| Foam density | kg/m³ | 32.1 | 30.6 | 33.3 | 35.0 | 36.5 | 39.2 | 44.5 |
| Gross calorific | 10 min | 14.7 | 5.9 | 5.0 | 4.7 | 4.7 | 4.3 | 3.9 |
| value | MJ/m² | | | | | | | |
| | 20 min | 17.9 | 8.7 | 7.8 | 6.7 | 6.9 | 5.5 | 6.3 |
| | MJ/m² | | | | | | | |
| Maximum heat | kW/m² | 84.7 | 65.3 | 52.5 | 53.4 | 44.1 | 44.9 | 42.3 |
| release rate | | | | | | | | |

Table 7 shows Experimental EXAMPLES dependent upon their respective amounts of the phosphoric ester within a range of 20 parts by weight to 140 parts by weight while the amount of the ammonium polyphosphate being fixed to be 100 parts by weight, per 100 parts by weight of the polyol compound.

TABLE 7

| | | | OH value/ | | | | | | | |
|---|---|---|---|---|---|---|---|---|---|---|
| Product | | | NCO | EXAMPLE | EXAMPLE | EXAMPLE | EXAMPLE | EXAMPLE | EXAMPLE | EXAMPLE |
| name | Composition | | content | 31 | 32 | 33 | 34 | 35 | 36 | 37 |
| MAXIMOL | A | Terephthalic acid | 200 | 100 | 100 | 100 | 100 | 100 | 100 | 100 |
| RFK-509 | | polyester polyol | | | | | | | | |
| TMR-7 | B2 | Trimerization | | 5 | 5 | 5 | 5 | 5 | 5 | 5 |
| | | catalyst | | | | | | | | |
| BiCAT | B1 | Catalyst | | 2 | 2 | 2 | 2 | 2 | 2 | 2 |
| 8210 | | | | | | | | | | |
| POLYCAT | B3 | Trimerization | | 5 | 5 | 5 | 5 | 5 | 5 | 5 |
| 46 | | catalyst | | | | | | | | |
| Taien CII | C1 | Flame retardant | | 100 | 100 | 100 | 100 | 100 | 100 | 100 |
| | | ammonium | | | | | | | | |
| | | polyphosphate | | | | | | | | |
| TCPP | C2 | Flame retardant | | 20 | 40 | 60 | 80 | 100 | 120 | 140 |
| | | phosphoric ester | | | | | | | | |
| Solstice | D1 | Foaming agent | | 40 | 40 | 40 | 40 | 40 | 40 | 40 |
| LBA | | HFO-1233zd | | | | | | | | |
| Opteon | D2 | Foaming agent | | 20 | 20 | 20 | 20 | 20 | 20 | 20 |
| 1100 | | HFO-1336mzz | | | | | | | | |
| Water | D3 | Foaming agent | 6234 | 0.5 | 0.5 | 0.5 | 0.5 | 0.5 | 0.5 | 0.5 |
| (H₂O) | | water (H₂O) | | | | | | | | |
| Polyol premix total | | | | 292.50 | 312.50 | 332.50 | 352.50 | 372.50 | 392.50 | 412.50 |
| PM-200 | I | Polyisocyanate | 31 | 292.50 | 312.50 | 332.50 | 352.50 | 372.50 | 392.50 | 412.50 |
| | | polymeric MDI | | | | | | | | |

| Polyol premix hydroxyl value | | 79.03 | 73.97 | 69.52 | 65.58 | 62.06 | 58.90 | 56.04 |
|---|---|---|---|---|---|---|---|---|
| NCO Index | | 524 | 560 | 596 | 632 | 667 | 703 | 739 |
| | | EXAMPLE | EXAMPLE | EXAMPLE | EXAMPLE | EXAMPLE | EXAMPLE | EXAMPLE |
| CCM Result | | 31 | 32 | 33 | 34 | 35 | 36 | 37 |
| Foam density | kg/m³ | 34.3 | 34.5 | 37.2 | 38.2 | 38.7 | 42.2 | 50.2 |
| Gross calorific | 10 min | 16.8 | 11.6 | 5.3 | 4.1 | 5.0 | 4.8 | 4.7 |
| value | MJ/m² | | | | | | | |
| | 20 min | 24.0 | 14.2 | 7.6 | 6.2 | 7.1 | 7.7 | 7.1 |
| | MJ/m² | | | | | | | |
| Maximum heat | kW/m² | 96.0 | 92.8 | 58.0 | 47.6 | 59.4 | 49.0 | 46.9 |
| release rate | | | | | | | | |

Table 8 shows Experimental EXAMPLES dependent upon their respective amounts of the phosphoric ester within a range of 20 parts by weight to 140 parts by weight while the amount of the ammonium polyphosphate being fixed to be 125 parts by weight, per 100 parts by weight of the polyol compound.

TABLE 8

| | | | OH value/ | EX- | EX- | EX- | EX- | EX- | EX- | EX- |
|---|---|---|---|---|---|---|---|---|---|---|
| Product | | | NCO | AMPLE | AMPLE | AMPLE | AMPLE | AMPLE | AMPLE | AMPLE |
| name | Composition | | content | 38 | 39 | 40 | 41 | 42 | 43 | 44 |
| MAXIMOL | A | Terephthalic acid | 200 | 100 | 100 | 100 | 100 | 100 | 100 | 100 |
| RFK-509 | | polyester polyol | | | | | | | | |
| TMR-7 | B2 | Trimerization | | 5 | 5 | 5 | 5 | 5 | 5 | 5 |
| | | catalyst | | | | | | | | |
| BiCAT | B1 | Catalyst | | 2 | 2 | 2 | 2 | 2 | 2 | 2 |
| 8210 | | | | | | | | | | |
| POLYCAT | B3 | Trimerization | | 5 | 5 | 5 | 5 | 5 | 5 | 5 |
| 46 | | catalyst | | | | | | | | |
| Taien CII | C1 | Flame retardant | | 125 | 125 | 125 | 125 | 125 | 125 | 125 |
| | | ammonium | | | | | | | | |
| | | polyphosphate | | | | | | | | |
| TCPP | C2 | Flame retardant | | 20 | 40 | 60 | 80 | 100 | 120 | 140 |
| | | phosphoric ester | | | | | | | | |
| Solstice | D1 | Foaming agent | | 40 | 40 | 40 | 40 | 40 | 40 | 40 |
| LBA | | HFO-1233zd | | | | | | | | |
| Opteon | D2 | Foaming agent | | 20 | 20 | 20 | 20 | 20 | 20 | 20 |
| 1100 | | HFO-1336mzz | | | | | | | | |
| Water | D3 | Foaming agent | 6234 | 0.5 | 0.5 | 0.5 | 0.5 | 0.5 | 0.5 | 0.5 |
| (H₂O) | | water (H₂O) | | | | | | | | |
| Polyol premix total | | | | 317.50 | 337.50 | 357.50 | 377.50 | 397.50 | 417.50 | 437.50 |
| PM-200 | I | Polyisocyanate | 31 | 317.50 | 337.50 | 357.50 | 377.50 | 397.50 | 417.50 | 437.50 |
| | | polymeric MDI | | | | | | | | |

| Polyol premix hydroxyl value | | 72.81 | 68.49 | 64.66 | 61.24 | 58.16 | 55.37 | 52.84 |
|---|---|---|---|---|---|---|---|---|
| NCO Index | | 569 | 605 | 640 | 676 | 712 | 748 | 784 |
| | | EX- | EX- | EX- | EX- | EX- | EX- | EX- |
| | | AMPLE | AMPLE | AMPLE | AMPLE | AMPLE | AMPLE | AMPLE |
| CCM Result | | 38 | 39 | 40 | 41 | 42 | 43 | 44 |
| Foam density | kg/m³ | 37.8 | 38.8 | 40.0 | 42.5 | 43.2 | 47.2 | 54.1 |
| Gross calorific | 10 min | 20.2 | 15.6 | 16.0 | 15.6 | 11.6 | 8.3 | 5.7 |
| value | MJ/m² | | | | | | | |
| | 20 min | 29.6 | 21.5 | 21.7 | 20.9 | 15.6 | 11.6 | 10.3 |
| | MJ/m² | | | | | | | |
| Maximum heat | kW/m² | 110.1 | 121.0 | 97.5 | 98.0 | 84.1 | 66.4 | 62.2 |
| release rate | | | | | | | | |

### (2.1) Isocyanate Index

Table 9 shows the isocyanate index (NCO Index) in each of Experimental EXAMPLES 3 to 44 in a matrix form.

TABLE 9
NCO Index (Isocyanate index)

| | | Ammonium Polyphosphate | | | | | |
|---|---|---|---|---|---|---|---|
| | | 20 | 40 | 50 | 75 | 100 | 125 |
| Phosphoric | 20 | 381 | 417 | 434 | 479 | 524 | 569 |
| ester | 40 | 417 | 452 | 470 | 515 | 560 | 605 |
| | 60 | 452 | 488 | 506 | 551 | 596 | 640 |
| | 80 | 488 | 524 | 542 | 587 | 632 | 676 |
| | 100 | 524 | 560 | 578 | 623 | 667 | 712 |
| | 120 | 560 | 596 | 614 | 658 | 703 | 748 |
| | 140 | 596 | 632 | 649 | 694 | 739 | 784 |

As shown in Table 9, the isocyanate index of each foam body falls within a range of 381 to 784, that is a range of approximately 400 to approximately 800.

### (2.2) Quasi-Uninflammability Evaluated by Heat Release Test

Table 10 shows the gross calorific value of the specimen when heated for 10 minutes in the heat release test in each of Experimental EXAMPLES 3 to 44 in a matrix form.

TABLE 10
10-min Gross Calorific Value

| | | Ammonium Polyphosphate | | | | | |
|---|---|---|---|---|---|---|---|
| | | 20 | 40 | 50 | 75 | 100 | 125 |
| Phosphoric | 20 | 9.4 | 13.5 | 16.4 | 14.7 | 16.8 | 20.2 |
| ester | 40 | 4.5 | 5.2 | 4.9 | 5.9 | 11.6 | 15.6 |
| | 60 | 4.0 | 5.2 | 4.1 | 5.0 | 5.3 | 16.0 |
| | 80 | 5.1 | 4.7 | 4.6 | 4.7 | 4.1 | 15.6 |
| | 100 | Undetected | 4.7 | 5.8 | 4.7 | 5.0 | 11.6 |
| | 120 | Undetected | 5.6 | 4.9 | 4.3 | 4.8 | 8.3 |
| | 140 | Undetected | 7.1 | 6.9 | 3.9 | 4.7 | 5.7 |

According to Table 10, it was found that the specimen containing the ammonium polyphosphate and the phosphoric ester having their respective amounts per 100 parts by weight of the polyol compound falling within the following ranges was equivalent to the quasi-uninflammable material:

### Range (1) of Amount

Ammonium polyphosphate/parts by weight: 20 or more and 75 or less
Phosphoric ester/parts by weight: 40 or more and 80 or less

### Range (2) of Amount

Ammonium polyphosphate/parts by weight: 20 or more and 100 or less
Phosphoric ester/parts by weight: 60 or more and 80 or less

### Range (3) of Amount

Ammonium polyphosphate/parts by weight: 40 or more and 75 or less
Phosphoric ester/parts by weight: 40 or more and 140 or less

### Range (4) of Amount

Ammonium polyphosphate/parts by weight: 40 or more and 100 or less
Phosphoric ester/parts by weight: 60 or more and 140 or less

### Range (5) of Amount

Ammonium polyphosphate/parts by weight: 40 or more and 125 or less
Phosphoric ester/parts by weight: 140

### (2.3) Uninflammability Evaluated by Heat Release Test

Table 11 shows the gross calorific value of the specimen when heated for 20 minutes in the heat release test in each of Experimental EXAMPLES 3 to 44 in a matrix form.

TABLE 11
20-min Gross Calorific Value

| | | Ammonium Polyphosphate | | | | | |
|---|---|---|---|---|---|---|---|
| | | 20 | 40 | 50 | 75 | 100 | 125 |
| Phosphoric | 20 | 13.4 | 19.6 | 22.4 | 17.9 | 24.0 | 29.6 |
| ester | 40 | 7.1 | 7.7 | 7.4 | 8.7 | 14.2 | 21.5 |
| | 60 | 5.6 | 8.0 | 5.3 | 7.8 | 7.6 | 21.7 |
| | 80 | 7.1 | 6.4 | 6.2 | 6.7 | 6.2 | 20.9 |
| | 100 | Undetected | 7.1 | 8.0 | 6.9 | 7.1 | 15.6 |
| | 120 | Undetected | 7.4 | 6.4 | 5.5 | 7.7 | 11.6 |
| | 140 | Undetected | 9.7 | 11.7 | 6.3 | 7.1 | 10.3 |

According to Table 11, it was found that the specimen containing the ammonium polyphosphate and the phosphoric ester having their respective amounts per 100 parts by weight of the polyol compound falling within the following ranges was equivalent to the uninflammable material:

### Range (6) of Amount

Ammonium polyphosphate/parts by weight: 20 or more and 50 or less
Phosphoric ester/parts by weight: 40 or more and 80 or less

### Range (7) of Amount

Ammonium polyphosphate/parts by weight: 20 or more and 100 or less
Phosphoric ester/parts by weight: 60 or more and 80 or less

### Range (8) of Amount

Ammonium polyphosphate/parts by weight: 40 or more and 50 or less
Phosphoric ester/parts by weight: 40 or more and 120 or less

### Range (9) of Amount

Ammonium polyphosphate/parts by weight: 40 or more and 100 or less
Phosphoric ester/parts by weight: 60 or more and 120 or less

### Range (10) of Amount

Ammonium polyphosphate/parts by weight: 75 or more and 100 or less
Phosphoric ester/parts by weight: 60 or more and 140 or less

### (3) Experimental Examples 20, 45 to 48 (Table 12)

Further subsequently, Table 12 shows Experimental EXAMPLES 20, 45 to 48 where each specimen containing the ammonium polyphosphate of 50 parts by weight and the phosphoric ester of 80 parts by weight per 100 parts, by weight of the polyol compound, further contains the fired kaolin as the mineral-derived material.

TABLE 12

| Product | | | OH value/ | EXAMPLE | EXAMPLE | EXAMPLE | EXAMPLE | EXAMPLE |
|---|---|---|---|---|---|---|---|---|
| name | Composition | | NCO content | 20 | 45 | 46 | 47 | 48 |
| MAXIMOL | A | Terephthalic acid | 200 | 100 | 100 | 100 | 100 | 100 |
| RFK-509 | | polyester polyol | | | | | | |
| SH-193 | E | Silicone-based | | | | | | |
| | | foam stabilizer | | | | | | |
| SEI-W01 | F | Surface conditioner | | | | | | |
| LS-106 | G1 | Compatibilizer | | | | | | |
| NP-9 | G2 | Compatibilizer | | | | | | |
| BiCAT | B1 | Catalyst | | 2 | 2 | 2 | 2 | 2 |
| 8210 | | | | | | | | |
| TMR-7 | B2 | Trimerization | | 5 | 5 | 5 | 5 | 5 |
| | | catalyst | | | | | | |
| POLYCAT | B3 | Trimerization | | 5 | 5 | 5 | 5 | 5 |
| 46 | | catalyst | | | | | | |
| Glomax | H | Fired kaolin | | | 3 | 25 | 50 | 75 |
| LL | | | | | | | | |
| Taien CII | C1 | Flame retardant | | 50 | 50 | 50 | 50 | 50 |
| | | ammonium | | | | | | |
| | | polyphosphate | | | | | | |
| TCPP | C2 | Flame retardant | | 80 | 80 | 80 | 80 | 80 |
| | | phosphoric ester | | | | | | |
| Solstice | D1 | Foaming agent | | 40 | 40 | 40 | 40 | 40 |
| LBA | | HFO-1233zd | | | | | | |
| Opteon | D2 | Foaming agent | | 20 | 20 | 20 | 20 | 20 |
| 1100 | | HFO-1336mzz | | | | | | |
| Water | D3 | Foaming agent | 6234 | 0.5 | 0.5 | 0.5 | 0.5 | 0.5 |
| (H₂O) | | water (H₂O) | | | | | | |
| Polyol premix total | | | | 302.50 | 305.50 | 327.50 | 352.50 | 377.50 |
| PM-200 | I | Polyisocyanate | 31 | 302.50 | 305.50 | 327.50 | 352.50 | 377.50 |
| | | polymeric MDI | | | | | | |

| Polyol premix hydroxyl value | | 76.42 | 75.67 | 70.59 | 65.58 | 61.24 |
|---|---|---|---|---|---|---|
| NCO Index | | 542 | 547 | 587 | 632 | 676 |
| | | EXAMPLE | EXAMPLE | EXAMPLE | EXAMPLE | EXAMPLE |
| CCM Result | | 20 | 45 | 46 | 47 | 48 |
| Foam density | kg/m³ | 32.4 | 32.3 | 36.3 | 39.6 | 44.1 |
| Gross calorific | 10 min | 4.8 | 4.5 | 5.0 | 5.0 | 6.8 |
| value | MJ/m² | | | | | |
| | 20 min | 6.7 | 6.3 | 7.3 | 7.5 | 10.7 |
| | MJ/m² | | | | | |
| Maximum heat | kW/m² | 49.0 | 49.6 | 43.8 | 42.5 | 45.5 |
| release rate | | | | | | |

According to Table 12, it was found that each specimen in Experimental EXAMPLES 45 to 47, in the same manner as that in Experimental EXAMPLE 20, was equivalent to the uninflammable material, and the specimen in Experimental EXAMPLE 48 was equivalent to the quasi-uninflammable material.

For this reason, it was considered that the addition of fired kaolin does not have any large effect on the reduction of flame retardancy.

### (4) Experimental Examples 20, 49 to 52 (Table 13)

Further subsequently, Table 13 shows Experimental EXAMPLES 20, 49 to 52 where each specimen containing the ammonium polyphosphate of 50 parts by weight and the phosphoric ester of 80 parts by weight per 100 parts, by weight of the polyol compound, further contains any of the foam stabilizer, surface conditioner, and compatibilizer.

TABLE 13

| Product | | | OH value/ | EXAMPLE | EXAMPLE | EXAMPLE | EXAMPLE | EXAMPLE |
|---|---|---|---|---|---|---|---|---|
| name | Composition | | NCO content | 20 | 49 | 50 | 51 | 52 |
| MAXIMOL | A | Terephthalic acid | 200 | 100 | 100 | 100 | 100 | 100 |
| RFK-509 | | polyester polyol | | | | | | |
| SH-193 | E | Silicone-based | | | 3 | | | |
| | | foam stabilizer | | | | | | |
| SEI-W01 | F | Surface conditioner | | | | 3 | | |
| LS-106 | G1 | Compatibilizer | | | | | 3 | |
| NP-9 | G2 | Compatibilizer | | | | | | 3 |
| BiCAT | B1 | Catalyst | | 2 | 2 | 2 | 2 | 2 |
| 8210 | | | | | | | | |
| TMR-7 | B2 | Trimerization | | 5 | 5 | 5 | 5 | 5 |
| | | catalyst | | | | | | |
| POLYCAT | B3 | Trimerization | | 5 | 5 | 5 | 5 | 5 |
| 46 | | catalyst | | | | | | |
| Glomax | H | Fired kaolin | | | | | | |
| LL | | | | | | | | |
| Taien CII | C1 | Flame retardant | | 50 | 50 | 50 | 50 | 50 |
| | | ammonium | | | | | | |
| | | polyphosphate | | | | | | |
| TCPP | C2 | Flame retardant | | 80 | 80 | 80 | 80 | 80 |
| | | phosphoric ester | | | | | | |
| Solstice | D1 | Foaming agent | | 40 | 40 | 40 | 40 | 40 |
| LBA | | HFO-1233zd | | | | | | |
| Opteon | D2 | Foaming agent | | 20 | 20 | 20 | 20 | 20 |
| 1100 | | HFO-1336mzz | | | | | | |
| Water | D3 | Foaming agent | 6234 | 0.5 | 0.5 | 0.5 | 0.5 | 0.5 |
| (H₂O) | | water (H₂O) | | | | | | |
| Polyol premix total | | | | 302.50 | 305.50 | 305.50 | 305.50 | 305.50 |
| PM-200 | I | Polyisocyanate | 31 | 302.50 | 305.50 | 305.50 | 305.50 | 305.50 |
| | | polymeric MDI | | | | | | |

| Polyol premix hydroxyl value | | 76.42 | 75.67 | 75.67 | 75.67 | 75.67 |
|---|---|---|---|---|---|---|
| NCO Index | | 542 | 547 | 547 | 547 | 547 |
| | | EXAMPLE | EXAMPLE | EXAMPLE | EXAMPLE | EXAMPLE |
| CCM Result | | 20 | 49 | 50 | 51 | 52 |
| Foam density | kg/m³ | 32.4 | 33.1 | 33.8 | 33.2 | 32.6 |
| Gross calorific | 10 min | 4.8 | 5.8 | 3.7 | 4.9 | 5.6 |
| value | MJ/m² | | | | | |
| | 20 min | 6.7 | 7.4 | 5.7 | 6.7 | 6.8 |
| | MJ/m² | | | | | |
| Maximum heat | kW/m² | 49.0 | 46.5 | 31.1 | 49.3 | 43.2 |
| release rate | | | | | | |

According to Table 13, it was found that each specimen in Experimental EXAMPLES 49 to 52, in the same manner as that in Experimental EXAMPLE 20, was equivalent to the uninflammable material.

For this reason, it was considered that the addition of foam stabilizer, surface conditioner, and compatibilizer does not have any large effect on the reduction of flame retardancy.

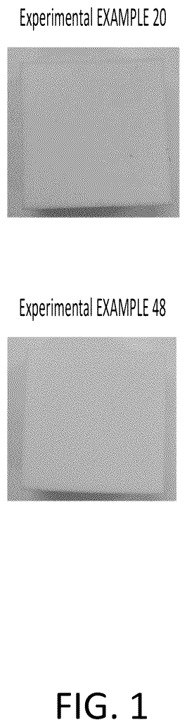

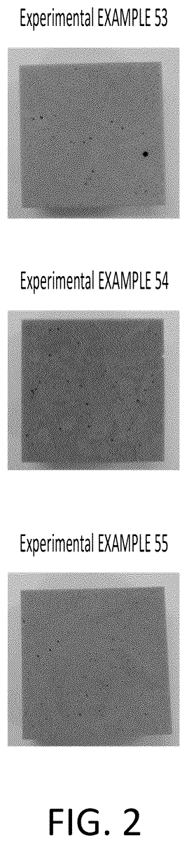

### (5) Experimental Examples 53 to 55 (Table 14, FIGS. 1, 2)

Further subsequently, a comparison in hue of foam body was made among the specimens containing the fired kaolin (the same material as the above-described (H)) and the red phosphorus (C3: available from RIN KAGAKU KOGYO Co., Ltd., product name: Nova Excel 140) having their respective amounts, per 100 parts by weight of the polyol compound, combinations of which are shown in Table 14 below:

TABLE 14

| Product | | | OH value/ | EXAMPLE | EXAMPLE | EXAMPLE | EXAMPLE | EXAMPLE |
|---|---|---|---|---|---|---|---|---|
| name | Composition | | NCO content | 20 | 48 | 53 | 54 | 55 |
| MAXIMOL | A | Terephthalic acid | 200 | 100 | 100 | 100 | 100 | 100 |
| RFK-509 | | polyester polyol | | | | | | |
| BiCAT | B1 | Catalyst | | 2 | 2 | 2 | 2 | 2 |
| 8210 | | | | | | | | |
| TMR-7 | B2 | Trimerization | | 5 | 5 | 5 | 5 | 5 |
| | | catalyst | | | | | | |
| POLYCAT | B3 | Trimerization | | 5 | 5 | 5 | 5 | 5 |
| 46 | | catalyst | | | | | | |
| Glomax | H | Fired kaolin | | | 75 | | | 75 |
| LL | | | | | | | | |
| Nova | C3 | Red phosphorus | | | | 25 | 50 | 50 |
| Excel 140 | | | | | | | | |
| Taien CII | C1 | Flame retardant | | 50 | 50 | 25 | | |
| | | ammonium | | | | | | |
| | | polyphosphate | | | | | | |
| TCPP | C2 | Flame retardant | | 80 | 80 | 80 | 80 | 80 |
| | | phosphoric ester | | | | | | |
| Solstice | D1 | Foaming agent | | 40 | 40 | 40 | 40 | 40 |
| LBA | | HFO-1233zd | | | | | | |
| Opteon | D2 | Foaming agent | | 20 | 20 | 20 | 20 | 20 |
| 1100 | | HFO-1336mzz | | | | | | |
| Water | D3 | Foaming agent | 6234 | 0.5 | 0.5 | 0.5 | 0.5 | 0.5 |
| (H₂O) | | water (H₂O) | | | | | | |
| Polyol premix total | | | | 302.50 | 377.50 | 302.50 | 302.50 | 377.50 |
| PM-200 | I | Polyisocyanate | 31 | 302.50 | 377.50 | 302.50 | 302.50 | 377.50 |
| | | polymeric MDI | | | | | | |

| Polyol premix hydroxyl value | | 76.42 | 61.24 | 76.42 | 76.42 | 61.24 |
|---|---|---|---|---|---|---|
| NCO Index | | 542 | 676 | 542 | 542 | 676 |
| | | EXAMPLE | EXAMPLE | EXAMPLE | EXAMPLE | EXAMPLE |
| CCM Result | | 20 | 48 | 53 | 54 | 55 |
| Foam density | kg/m³ | 33.9 | 44.1 | 31.4 | 31.8 | 40.6 |
| Gross calorific | 10 min | 4.6 | 6.8 | 3.8 | 4.3 | 4.3 |
| value | MJ/m² | | | | | |
| | 20 min | 6.2 | 10.7 | 5.9 | 5.1 | 6.4 |
| | MJ/m² | | | | | |
| Maximum heat | kW/m² | 26.6 | 45.5 | 48.7 | 76.6 | 58.7 |
| release rate | | | | | | |

FIGS. 1, 2 depict views of photographs for comparison in hue of foam body among Experimental EXAMPLES 20, 48, 53 to 55. Each view is obtained by having taken a photograph of each foam body arranged in a white background.

The foam body according to an embodiment of the present invention as shown in FIG. 1 (foam bodies in Experimental EXAMPLES 20, 48, respectively) takes on white-based or beige-based hue substantially close to a background hue, and is therefore allowed to be colored such that it can take on any sorts of hue.

On the other hand, it was found in FIG. 2 that the foam body in Experimental EXAMPLES 53 to 55 containing the red phosphorus takes on reddish-brown-based hue distinct from a background hue, and for this reason, has a restricted degree of freedom in coloring in contrast to that according to an embodiment of the present invention.

### (6) Experimental Examples 56 to 59 (Table 15)

Further subsequently, Table 15 shows Experimental EXAMPLES 56 to 59 dependent upon various products containing the ammonium polyphosphate while the amounts of the ammonium polyphosphate and the phosphoric ester being fixed to be 50 parts by weight and 80 parts by weight, respectively, per 100 parts by weight of the polyol compound.

TABLE 15

| Product | | | OH value/ | EXAMPLE | EXAMPLE | EXAMPLE | EXAMPLE | EXAMPLE |
|---|---|---|---|---|---|---|---|---|
| name | Composition | | NCO content | 20 | 56 | 57 | 58 | 59 |
| MAXIMOL | A | Terephthalic acid | 200 | 100 | 100 | 100 | 100 | 100 |
| RFK-509 | | polyester polyol | | | | | | |
| BiCAT | B1 | Catalyst | | 2 | 2 | 2 | 2 | 2 |
| 8210 | | | | | | | | |
| TMR-7 | B2 | Trimerization | | 5 | 5 | 5 | 5 | 5 |
| | | catalyst | | | | | | |
| POLYCAT | B3 | Trimerization | | 5 | 5 | 5 | 5 | 5 |
| 46 | | catalyst | | | | | | |
| Taien CII | C1 | Flame retardant | | 50 | | | | |
| NNA21 | C1-1 | ammonium | | | 50 | | | |
| AP766 | C1-2 | polyphosphate | | | | 50 | | |
| AP750 | C1-3 | | | | | | 50 | |
| AP422 | C1-4 | | | | | | | 50 |
| TCPP | C2 | Flame retardant | | 80 | 80 | 80 | 80 | 80 |
| | | phosphoric ester | | | | | | |
| Solstice | D1 | Foaming agent | | 40 | 40 | 40 | 40 | 40 |
| LBA | | HFO-1233zd | | | | | | |
| Opteon | D2 | Foaming agent | | 20 | 20 | 20 | 20 | 20 |
| 1100 | | HFO-1336mzz | | | | | | |
| Water | D3 | Foaming agent | 6234 | 0.5 | 0.5 | 0.5 | 0.5 | 0.5 |
| (H₂O) | | water (H₂O) | | | | | | |
| Polyol premix total | | | | 302.50 | 302.50 | 302.50 | 302.50 | 302.50 |
| PM-200 | I | Polyisocyanate | 31 | 302.50 | 302.50 | 302.50 | 302.50 | 302.50 |
| | | polymeric MDI | | | | | | |

| Polyol premix hydroxyl value | | 76.42 | 76.42 | 76.42 | 76.42 | 76.42 |
|---|---|---|---|---|---|---|
| NCO Index | | 542 | 542 | 542 | 542 | 542 |
| | | EXAMPLE | EXAMPLE | EXAMPLE | EXAMPLE | EXAMPLE |
| CCM Result | | 20 | 56 | 57 | 58 | 59 |
| Foam density | kg/m³ | 32.4 | 32.4 | 32.7 | 30.2 | 30.6 |
| Gross calorific | 10 min | 4.8 | 5.5 | 5.0 | 5.4 | 5.3 |
| value | MJ/m² | | | | | |
| | 20 min | 6.7 | 7.1 | 6.8 | 7.3 | 7.1 |
| | MJ/m² | | | | | |
| Maximum heat | kW/m² | 49.0 | 52.6 | 49.1 | 40.0 | 45.2 |
| release rate | | | | | | |

According to Table 15, it was found that each specimen in Experimental EXAMPLES 56 to 59, in the same manner as that in Experimental EXAMPLE 20, was equivalent to the uninflammable material.

### (7) Experimental Examples 60 to 63 (Table 16)

Further subsequently, Table 16 shows Experimental EXAMPLES 60 to 63 dependent upon various products containing the polyphosphoric ester while the amounts of the ammonium polyphosphate and the phosphoric ester being fixed to be 50 parts by weight and 80 parts by weight, respectively, per 100 parts by weight of the polyol compound.

TABLE 16

| Product | | | OH value/ | EXAMPLE | EXAMPLE | EXAMPLE | EXAMPLE | EXAMPLE |
|---|---|---|---|---|---|---|---|---|
| name | Composition | | NCO content | 20 | 60 | 61 | 62 | 63 |
| MAXIMOL | A | Terephthalic acid | 200 | 100 | 100 | 100 | 100 | 100 |
| RFK-509 | | polyester polyol | | | | | | |
| BiCAT | B1 | Catalyst | | 2 | 2 | 2 | 2 | 2 |
| 8210 | | | | | | | | |
| TMR-7 | B2 | Trimerization | | 5 | 5 | 5 | 5 | 5 |
| | | catalyst | | | | | | |
| POLYCAT | B3 | Trimerization | | 5 | 5 | 5 | 5 | 5 |
| 46 | | catalyst | | | | | | |
| Taien CII | C1 | Flame retardant | | 50 | 50 | 50 | 50 | 50 |
| | | ammonium | | | | | | |
| | | polyphosphate | | | | | | |
| TCPP | C2 | Flame retardant | | 80 | | | | |
| TCP | C2-1 | phosphoric ester | | | 80 | | | |
| TEP | C2-2 | | | | | 80 | | |
| TXP | C2-3 | | | | | | 80 | |
| TCP | C2-4 | | | | | | | 80 |
| Solstice | D1 | Foaming agent | | 40 | 40 | 40 | 40 | 40 |
| LBA | | HFO-1233zd | | | | | | |
| Opteon | D2 | Foaming agent | | 20 | 20 | 20 | 20 | 20 |
| 1100 | | HFO-1336mzz | | | | | | |
| Water | D3 | Foaming agent | 6234 | 0.5 | 0.5 | 0.5 | 0.5 | 0.5 |
| (H₂O) | | water (H₂O) | | | | | | |
| Polyol premix total | | | | 302.50 | 302.50 | 302.50 | 302.50 | 302.50 |
| PM-200 | I | Polyisocyanate | 31 | 302.50 | 302.50 | 302.50 | 302.50 | 302.50 |
| | | polymeric MDI | | | | | | |

| Polyol premix hydroxyl value | | 76.42 | 76.42 | 76.42 | 76.42 | 76.42 |
|---|---|---|---|---|---|---|
| NCO Index | | 542 | 542 | 542 | 542 | 542 |
| | | EXAMPLE | EXAMPLE | EXAMPLE | EXAMPLE | EXAMPLE |
| CCM Result | | 20 | 60 | 61 | 62 | 63 |
| Foam density | kg/m³ | 32.4 | 34.5 | 30.1 | 34.7 | 34.6 |
| Gross calorific | 10 min | 4.8 | 3.2 | 5.4 | 3.5 | 3.8 |
| value | MJ/m² | | | | | |
| | 20 min | 6.7 | 4.2 | 7.1 | 4.5 | 5.7 |
| | MJ/m² | | | | | |
| Maximum heat | kW/m² | 49.0 | 53.8 | 68.9 | 52.1 | 32.6 |
| release rate | | | | | | |

According to Table 16, it was found that each specimen in Experimental EXAMPLES 60 to 63, in the same manner as that in Experimental EXAMPLE 20, was equivalent to the uninflammable material.

### (8) Experimental Examples 64 to 72 (Table 17)

Still further subsequently, Table 17 shows Experimental EXAMPLES 64 to 72 having the averaged results of larger sample number (N=3) than the above dependent upon various amounts of the ammonium polyphosphate and the phosphoric ester per 100 parts by weight of the polyol compound.

TABLE 17

| | | | OH | | | | | | | | | |
|---|---|---|---|---|---|---|---|---|---|---|---|---|
| | | | value/ | EX- | EX- | EX- | EX- | EX- | EX- | EX- | EX- | EX- |
| Product | | | NCO | AMPLE | AMPLE | AMPLE | AMPLE | AMPLE | AMPLE | AMPLE | AMPLE | AMPLE |
| name | Composition | | content | 64 | 65 | 66 | 67 | 68 | 69 | 70 | 71 | 72 |
| MAXIMOL | A | Terephthalic | 200 | 100 | 100 | 100 | 100 | 100 | 100 | 100 | 100 | 100 |
| RFK-509 | | acid poly- | | | | | | | | | | |
| | | ester polyol | | | | | | | | | | |
| BiCAT | B1 | Catalyst | | 2 | 2 | 2 | 2 | 2 | 2 | 2 | 2 | 2 |
| 8210 | | | | | | | | | | | | |
| TMR-7 | B2 | Trimerization | | 5 | 5 | 5 | 5 | 5 | 5 | 5 | 5 | 5 |
| | | catalyst | | | | | | | | | | |
| POLYCAT | B3 | Trimerization | | 5 | 5 | 5 | 5 | 5 | 5 | 5 | 5 | 5 |
| 46 | | catalyst | | | | | | | | | | |
| Taien CII | C1 | Flame | | 40 | 50 | 75 | 40 | 50 | 75 | 40 | 50 | 75 |
| AP422 | C1- | retardant | | | | | | | | | | |
| | 4 | ammonium | | | | | | | | | | |
| | | polyphosphate | | | | | | | | | | |
| TCPP | C2 | Flame | | 40 | 40 | 40 | 60 | 60 | 60 | 80 | 80 | 80 |
| TCP | C2- | retardant | | | | | | | | | | |
| | 1 | phosphoric | | | | | | | | | | |
| | | ester | | | | | | | | | | |
| Solstice | D1 | Foaming agent | | 40 | 40 | 40 | 40 | 40 | 40 | 40 | 40 | 40 |
| LBA | | HFO-1233zd | | | | | | | | | | |
| Opteon | D2 | Foaming agent | | 20 | 20 | 20 | 20 | 20 | 20 | 20 | 20 | 20 |
| 1100 | | HFO- | | | | | | | | | | |
| | | 1336mzz | | | | | | | | | | |
| Water | D3 | Foaming agent | 6234 | 0.5 | 0.5 | 0.5 | 0.5 | 0.5 | 0.5 | 0.5 | 0.5 | 0.5 |
| (H20) | | water (H₂O) | | | | | | | | | | |
| Polyol premix total | | | | 252.50 | 262.50 | 287.50 | 272.50 | 282.50 | 307.50 | 292.50 | 302.50 | 327.50 |
| PM-200 | I | Polyisocyanate | 31 | 252.50 | 262.50 | 287.50 | 272.50 | 282.50 | 307.50 | 292.50 | 302.50 | 327.50 |
| | | polymeric | | | | | | | | | | |
| | | MDI | | | | | | | | | | |

| Polyol premix hydroxyl value | | 91.55 | 88.06 | 80.41 | 84.83 | 81.83 | 75.18 | 79.03 | 76.42 | 70.59 |
|---|---|---|---|---|---|---|---|---|---|---|
| NCO Index | | 452 | 470 | 515 | 488 | 506 | 551 | 524 | 542 | 587 |
| | | EX- | EX- | EX- | EX- | EX- | EX- | EX- | EX- | EX- |
| | | AMPLE | AMPLE | AMPLE | AMPLE | AMPLE | AMPLE | AMPLE | AMPLE | AMPLE |
| CCM Result | | 64 | 65 | 66 | 67 | 68 | 69 | 70 | 71 | 72 |
| Foam density | kg/m³ | 26.8 | 28.4 | 32.0 | 28.4 | 29.9 | 35.0 | 30.7 | 32.0 | 36.2 |
| Gross calorific | 10 min | 5.2 | 4.7 | 6.3 | 4.7 | 4.1 | 4.8 | 4.7 | 4.5 | 4.8 |
| value | MJ/m² | | | | | | | | | |
| | 20 min | 6.9 | 6.5 | 7.9 | 6.9 | 5.3 | 6.6 | 6.0 | 6.0 | 6.9 |
| | MJ/m² | | | | | | | | | |
| Maximum heat | kW/m² | 62.0 | 53.8 | 93.0 | 54.8 | 52.7 | 64.9 | 49.8 | 56.7 | 55.2 |
| release rate | | | | | | | | | | |

### (8.1) Quasi-Uninflammability Evaluated by Heat Release Test

Table 18 shows results obtained by replacing a part of the 10-min gross calorific values in the heat release test shown in a matrix form in Table 10 with those in Experimental EXAMPLES 64 to 72 in Table 17. It is to be noted that the numbers indicative of replaced values are emphasized by the underlined bold type.

TABLE 18
10-min Gross Calorific Value

| | | Ammonium Polyphosphate | | | | | |
|---|---|---|---|---|---|---|---|
| | | 20 | 40 | 50 | 75 | 100 | 125 |
| Phosphoric | 20 | 9.4 | 13.5 | 16.4 | 14.7 | 16.8 | 20.2 |
| ester | 40 | 4.5 | 5.2 | 4.7 | 6.3 | 11.6 | 15.6 |
| | 60 | 4.0 | 4.7 | 4.1 | 4.8 | 5.3 | 16.0 |
| | 80 | 5.1 | 4.7 | 4.5 | 4.8 | 4.1 | 15.6 |
| | 100 | Undetected | 4.7 | 5.8 | 4.7 | 5.0 | 11.6 |
| | 120 | Undetected | 5.6 | 4.9 | 4.3 | 4.8 | 8.3 |
| | 140 | Undetected | 7.1 | 6.9 | 3.9 | 4.7 | 5.7 |

According to Table 18, it was found that the specimen falling within the following ranges was equivalent to the quasi-uninflammable material:

### Range (A) of Amount Per 100 Parts by Weight of the Polyol Compound

Ammonium polyphosphate/parts by weight: 20 or more and 75 or less
Phosphoric ester/parts by weight: 40 or more and 80 or less

### Range (B) of Amount Per 100 Parts by Weight of the Polyol Compound

Ammonium polyphosphate/parts by weight: 20 or more and 100 or less
Phosphoric ester/parts by weight: 60 or more and 80 or less

### Range (C) of Amount Per 100 Parts by Weight of the Polyol Compound

Ammonium polyphosphate/parts by weight: 40 or more and 75 or less
Phosphoric ester/parts by weight: 40 or more and 140 or less

### Range (D) of Amount Per 100 Parts by Weight of the Polyol Compound

Ammonium polyphosphate/parts by weight: 40 or more and 100 or less
Phosphoric ester/parts by weight: 60 or more and 140 or less

### Range (E) of Amount Per 100 Parts by Weight of the Polyol Compound

Ammonium polyphosphate/parts by weight: 40 or more and 125 or less
Phosphoric ester/parts by weight: 140

### (8.2) Uninflammability Evaluated by Heat Release Test

Table 19 shows results obtained by replacing a part of the 20-min gross calorific values in the heat release test shown in a matrix form in Table 11 with those in Experimental EXAMPLES 64 to 72 in Table 17. It is to be noted that the numbers indicative of replaced values are emphasized by the underlined bold type.

TABLE 19
20-min Gross Calorific Value

| | | Ammonium Polyphosphate | | | | | |
|---|---|---|---|---|---|---|---|
| | | 20 | 40 | 50 | 75 | 100 | 125 |
| Phosphoric | 20 | 13.4 | 19.6 | 22.4 | 17.9 | 24.0 | 29.6 |
| ester | 40 | 7.1 | 6.9 | 6.5 | 7.9 | 14.2 | 21.5 |
| | 60 | 5.6 | 6.9 | 5.3 | 6.6 | 7.6 | 21.7 |
| | 80 | 7.1 | 6.0 | 6.0 | 6.9 | 6.2 | 20.9 |
| | 100 | Undetected | 7.1 | 8.0 | 6.9 | 7.1 | 15.6 |
| | 120 | Undetected | 7.4 | 6.4 | 5.5 | 7.7 | 11.6 |
| | 140 | Undetected | 9.7 | 11.7 | 6.3 | 7.1 | 10.3 |

According to Table 19, it was found that the specimen falling within the following ranges was equivalent to the uninflammable material:

### Range (F) of Amount Per 100 Parts by Weight of the Polyol Compound

Ammonium polyphosphate/parts by weight: 20 or more and 75 or less
Phosphoric ester/parts by weight: 40 or more and 80 or less

### Range (G) of Amount Per 100 Parts by Weight of the Polyol Compound

Ammonium polyphosphate/parts by weight: 40 or more and 75 or less
Phosphoric ester/parts by weight: 40 or more and 120 or less

### Range (H) of Amount Per 100 Parts by Weight of the Polyol Compound

Ammonium polyphosphate/parts by weight: 40 or more and 100 or less
Phosphoric ester/parts by weight: 60 or more and 120 or less

### Range (I) of Amount Per 100 Parts by Weight of the Polyol Compound

Ammonium polyphosphate/parts by weight: 75 or more and 100 or less
Phosphoric ester/parts by weight: 60 or more and 140 or less

It is to be noted that there was at least the fact that the specimen having the ammonium polyphosphate of 75 parts by weight and the phosphoric ester of 40 parts by weight per 100 parts by weight of the polyol compound did not arrive at uninflammable material as a result of the heat release test in Table 11, but the specimen having the same amount of contents arrived at uninflammable material as averaged results of larger sample number (N=3) of the heat release tests in Table 19.

### (9) Experimental Examples 73 to 99 (Table 20 to 22)

Still further subsequently, Tables 20 to 22 show results of Experimental EXAMPLES 73 to 99 which are the same in heat release test as Experimental EXAMPLES 64 to 72 in Table 17 dependent upon various products containing the ammonium polyphosphate and the phosphoric ester.

TABLE 20

| | | | OH | | | | | | | | | |
|---|---|---|---|---|---|---|---|---|---|---|---|---|
| | | | value/ | EX- | EX- | EX- | EX- | EX- | EX- | EX- | EX- | EX- |
| Product | | | NCO | AMPLE | AMPLE | AMPLE | AMPLE | AMPLE | AMPLE | AMPLE | AMPLE | AMPLE |
| name | Composition | | content | 73 | 74 | 75 | 76 | 77 | 78 | 79 | 80 | 81 |
| MAXIMOL | A | Terephthalic | 200 | 100 | 100 | 100 | 100 | 100 | 100 | 100 | 100 | 100 |
| RFK-509 | | acid polyester | | | | | | | | | | |
| | | polyol | | | | | | | | | | |
| BiCAT | B1 | Catalyst | | 2 | 2 | 2 | 2 | 2 | 2 | 2 | 2 | 2 |
| 8210 | | | | | | | | | | | | |
| TMR-7 | B2 | Trimerization | | 5 | 5 | 5 | 5 | 5 | 5 | 5 | 5 | 5 |
| | | catalyst | | | | | | | | | | |
| POLYCAT | B3 | Trimerization | | 5 | 5 | 5 | 5 | 5 | 5 | 5 | 5 | 5 |
| 46 | | catalyst | | | | | | | | | | |
| Taien CII | C1 | Flame | | 40 | 50 | 75 | 40 | 50 | 75 | 40 | 50 | 75 |
| AP422 | C1- | retardant | | | | | | | | | | |
| | 4 | ammonium | | | | | | | | | | |
| | | polyphosphate | | | | | | | | | | |
| TCPP | C2 | Flame | | | | | | | | | | |
| TCP | C2- | retardant | | 40 | 40 | 40 | 60 | 60 | 60 | 80 | 80 | 80 |
| | 1 | phosphoric | | | | | | | | | | |
| | | ester | | | | | | | | | | |
| Solstice | D1 | Foaming | | 40 | 40 | 40 | 40 | 40 | 40 | 40 | 40 | 40 |
| LBA | | agent HFO- | | | | | | | | | | |
| | | 1233zd | | | | | | | | | | |
| Opteon | D2 | Foaming | | 20 | 20 | 20 | 20 | 20 | 20 | 20 | 20 | 20 |
| 1100 | | agent HFO- | | | | | | | | | | |
| | | 1336mzz | | | | | | | | | | |
| Water | D3 | Foaming | 6234 | 0.5 | 0.5 | 0.5 | 0.5 | 0.5 | 0.5 | 0.5 | 0.5 | 0.5 |
| (H₂O) | | agent | | | | | | | | | | |
| | | water (H₂O) | | | | | | | | | | |
| Polyol premix total | | | | 252.50 | 262.50 | 287.50 | 272.50 | 282.50 | 307.50 | 292.50 | 302.50 | 327.50 |
| PM-200 | I | Polyisocyanate | 31 | 252.50 | 262.50 | 287.50 | 272.50 | 282.50 | 307.50 | 292.50 | 302.50 | 327.50 |
| | | polymeric | | | | | | | | | | |
| | | MDI | | | | | | | | | | |

| Polyol premix hydroxyl value | | 91.55 | 88.06 | 80.41 | 84.83 | 81.83 | 75.18 | 79.03 | 76.42 | 70.59 |
|---|---|---|---|---|---|---|---|---|---|---|
| NCO Index | | 452 | 470 | 515 | 488 | 506 | 551 | 524 | 542 | 587 |
| | | EX- | EX- | EX- | EX- | EX- | EX- | EX- | EX- | EX- |
| | | AMPLE | AMPLE | AMPLE | AMPLE | AMPLE | AMPLE | AMPLE | AMPLE | AMPLE |
| CCM Result | | 73 | 74 | 75 | 76 | 77 | 78 | 79 | 80 | 81 |
| Foam density | kg/m³ | 26.8 | 29.4 | 33.3 | 29.6 | 31.1 | 34.9 | 31.8 | 33.4 | 38.7 |
| Gross calorific | 10 min | 5.2 | 4.6 | 3.7 | 3.4 | 3.3 | 3.6 | 4.1 | 4.9 | 4.0 |
| value | MJ/m² | | | | | | | | | |
| | 20 min | 6.4 | 6.0 | 5.1 | 4.7 | 4.4 | 4.8 | 5.3 | 6.8 | 5.8 |
| | MJ/m² | | | | | | | | | |
| Maximum heat | kW/m² | 61.2 | 59.4 | 51.5 | 41.4 | 42.2 | 53.4 | 45.6 | 45.4 | 50.0 |
| release rate | | | | | | | | | | |

TABLE 21

| | | | OH | | | | | | | | | |
|---|---|---|---|---|---|---|---|---|---|---|---|---|
| | | | value/ | EX- | EX- | EX- | EX- | EX- | EX- | EX- | EX- | EX- |
| Product | | | NCO | AMPLE | AMPLE | AMPLE | AMPLE | AMPLE | AMPLE | AMPLE | AMPLE | AMPLE |
| name | Composition | | content | 82 | 83 | 84 | 85 | 86 | 87 | 88 | 89 | 90 |
| MAXIMOL | A | Terephthalic | 200 | 100 | 100 | 100 | 100 | 100 | 100 | 100 | 100 | 100 |
| RFK-509 | | acid | | | | | | | | | | |
| | | polyester | | | | | | | | | | |
| | | polyol | | | | | | | | | | |
| BiCAT | B1 | Catalyst | | 2 | 2 | 2 | 2 | 2 | 2 | 2 | 2 | 2 |
| 8210 | | | | | | | | | | | | |
| TMR-7 | B2 | Trimerization | | 5 | 5 | 5 | 5 | 5 | 5 | 5 | 5 | 5 |
| | | catalyst | | | | | | | | | | |
| POLYCAT | B3 | Trimerization | | 5 | 5 | 5 | 5 | 5 | 5 | 5 | 5 | 5 |
| 46 | | catalyst | | | | | | | | | | |
| Taien CII | C1 | Flame | | | | | | | | | | |
| AP422 | C1- | retardant | | 40 | 50 | 75 | 40 | 50 | 75 | 40 | 50 | 75 |
| | 4 | ammonium | | | | | | | | | | |
| | | polyphosphate | | | | | | | | | | |
| TCPP | C2 | Flame | | 40 | 40 | 40 | 60 | 60 | 60 | 80 | 80 | 80 |
| TCP | C2- | retardant | | | | | | | | | | |
| | 1 | phosphoric | | | | | | | | | | |
| | | ester | | | | | | | | | | |
| Solstice | D1 | Foaming | | 40 | 40 | 40 | 40 | 40 | 40 | 40 | 40 | 40 |
| LBA | | agent HFO- | | | | | | | | | | |
| | | 1233zd | | | | | | | | | | |
| Opteon | D2 | Foaming | | 20 | 20 | 20 | 20 | 20 | 20 | 20 | 20 | 20 |
| 1100 | | agent HFO- | | | | | | | | | | |
| | | 1336mzz | | | | | | | | | | |
| Water | D3 | Foaming agent | 6234 | 0.5 | 0.5 | 0.5 | 0.5 | 0.5 | 0.5 | 0.5 | 0.5 | 0.5 |
| (H₂O) | | water (H₂O) | | | | | | | | | | |
| Polyol premix total | | | | 252.50 | 262.50 | 287.50 | 272.50 | 282.50 | 307.50 | 292.50 | 302.50 | 327.50 |
| PM-200 | I | Polyisocyanate | 31 | 252.50 | 262.50 | 287.50 | 272.50 | 282.50 | 307.50 | 292.50 | 302.50 | 327.50 |
| | | polymeric | | | | | | | | | | |
| | | MDI | | | | | | | | | | |

| Polyol premix hydroxyl value | | 91.55 | 88.06 | 80.41 | 84.83 | 81.83 | 75.18 | 79.03 | 76.42 | 70.59 |
|---|---|---|---|---|---|---|---|---|---|---|
| NCO Index | | 452 | 470 | 515 | 488 | 506 | 551 | 524 | 542 | 587 |
| | | EX- | EX- | EX- | EX- | EX- | EX- | EX- | EX- | EX- |
| | | AMPLE | AMPLE | AMPLE | AMPLE | AMPLE | AMPLE | AMPLE | AMPLE | AMPLE |
| CCM Result | | 82 | 83 | 84 | 85 | 86 | 87 | 88 | 89 | 90 |
| Foam density | kg/m³ | 27.9 | 29.9 | 34.4 | 29.8 | 32.2 | 35.6 | 32.5 | 35.1 | 36.9 |
| Gross calorific | 10 min | 4.9 | 4.6 | 4.7 | 4.1 | 4.0 | 3.9 | 5.9 | 4.9 | 4.9 |
| value | MJ/m² | | | | | | | | | |
| | 20 min | 7.0 | 6.1 | 6.7 | 5.3 | 6.9 | 5.3 | 7.1 | 6.4 | 6.8 |
| | MJ/m² | | | | | | | | | |
| Maximum heat | kW/m² | 51.3 | 49.7 | 62.4 | 56.4 | 46.3 | 50.3 | 62.6 | 65.0 | 64.9 |
| release rate | | | | | | | | | | |

TABLE 22

| Product | | | OH value/ | EXAMPLE | EXAMPLE | EXAMPLE | EXAMPLE | EXAMPLE |
|---|---|---|---|---|---|---|---|---|
| name | Composition | | NCO content | 91 | 92 | 93 | 94 | 95 |
| MAXIMOL | A | Terephthalic acid | 200 | 100 | 100 | 100 | 100 | 100 |
| RFK-509 | | polyester polyol | | | | | | |
| BiCAT | B1 | Catalyst | | 2 | 2 | 2 | 2 | 2 |
| 8210 | | | | | | | | |
| TMR-7 | B2 | Trimerization | | 5 | 5 | 5 | 5 | 5 |
| | | catalyst | | | | | | |
| POLYCAT | B3 | Trimerization | | 5 | 5 | 5 | 5 | 5 |
| 46 | | catalyst | | | | | | |
| Taien CII | C1 | Flame retardant | | | | | | |
| AP422 | C1-4 | ammonium | | 40 | 50 | 75 | 40 | 50 |
| | | polyphosphate | | | | | | |
| TCPP | C2 | Flame retardant | | | | | | |
| TCP | C2-1 | phosphoric ester | | 40 | 40 | 40 | 60 | 60 |
| Solstice | D1 | Foaming agent | | 40 | 40 | 40 | 40 | 40 |
| LBA | | HFO-1233zd | | | | | | |
| Opteon | D2 | Foaming agent | | 20 | 20 | 20 | 20 | 20 |
| 1100 | | HFO-1336mzz | | | | | | |
| Water | D3 | Foaming agent | 6234 | 0.5 | 0.5 | 0.5 | 0.5 | 0.5 |
| (H₂O) | | water (H₂O) | | | | | | |
| Polyol premix total | | | | 252.50 | 262.50 | 287.50 | 272.50 | 282.50 |
| PM-200 | I | Polyisocyanate | 31 | 252.50 | 262.50 | 287.50 | 272.50 | 282.50 |
| | | polymeric MDI | | | | | | |

| Polyol premix hydroxyl value | | | | 91.55 | 88.06 | 80.41 | 84.83 | 81.83 |
|---|---|---|---|---|---|---|---|---|
| NCO Index | | | | 452 | 470 | 515 | 488 | 506 |
| | Product | | | OH value/ | EXAMPLE | EXAMPLE | EXAMPLE | EXAMPLE |
| | name | Composition | | NCO content | 96 | 97 | 98 | 99 |
| | MAXIMOL | A | Terephthalic acid | 200 | 100 | 100 | 100 | 100 |
| | RFK-509 | | polyester polyol | | | | | |
| | BiCAT | B1 | Catalyst | | 2 | 2 | 2 | 2 |
| | 8210 | | | | | | | |
| | TMR-7 | B2 | Trimerization | | 5 | 5 | 5 | 5 |
| | | | catalyst | | | | | |
| | POLYCAT | B3 | Trimerization | | 5 | 5 | 5 | 5 |
| | 46 | | catalyst | | | | | |
| | Taien CII | C1 | Flame retardant | | | | | |
| | AP422 | C1-4 | ammonium | | 75 | 40 | 50 | 75 |
| | | | polyphosphate | | | | | |
| | TCPP | C2 | Flame retardant | | | | | |
| | TCP | C2-1 | phosphoric ester | | 60 | 80 | 80 | 80 |
| | Solstice | D1 | Foaming agent | | 40 | 40 | 40 | 40 |
| | LBA | | HFO-1233zd | | | | | |
| | Opteon | D2 | Foaming agent | | 20 | 20 | 20 | 20 |
| | 1100 | | HFO-1336mzz | | | | | |
| | Water | D3 | Foaming agent | 6234 | 0.5 | 0.5 | 0.5 | 0.5 |
| | (H₂O) | | water (H₂O) | | | | | |
| | Polyol premix total | | | | 307.50 | 292.50 | 302.50 | 327.50 |
| | PM-200 | I | Polyisocyanate | 31 | 307.50 | 292.50 | 302.50 | 327.50 |
| | | | polymeric MDI | | | | | |

| | | | | |
|---|---|---|---|---|
| Polyol premix hydroxyl value | 75.18 | 79.03 | 76.42 | 70.59 |
| NCO Index | 551 | 524 | 542 | 587 |

| | | EXAMPLE | EXAMPLE | EXAMPLE | EXAMPLE | EXAMPLE |
|---|---|---|---|---|---|---|
| CCM Result | | 91 | 92 | 93 | 94 | 95 |
| Foam density | kg/m³ | 27.5 | 28.8 | 33.5 | 28.7 | 30.8 |
| Gross calorific | 10 min | 5.7 | 5.9 | 5.7 | 6.1 | 5.4 |
| value | MJ/m² | | | | | |
| | 20 min | 7.4 | 7.8 | 7.7 | 7.7 | 6.7 |
| | MJ/m² | | | | | |
| Maximum heat | kW/m² | 72.3 | 67.9 | 79.5 | 62.9 | 57.0 |
| release rate | | | | | | |

| | | EXAMPLE | EXAMPLE | EXAMPLE | EXAMPLE |
|---|---|---|---|---|---|
| CCM Result | | 96 | 97 | 98 | 99 |
| Foam density | kg/m³ | 34.3 | 30.9 | 32.2 | 36.3 |
| Gross calorific | 10 min | 4.5 | 6.0 | 5.3 | 5.6 |
| value | MJ/m² | | | | |
| | 20 min | 6.4 | 7.3 | 6.6 | 7.5 |
| | MJ/m² | | | | |
| Maximum heat | kW/m² | 63.9 | 63.1 | 66.0 | 60.5 |
| release rate | | | | | |

As shown in Tables 17, 20 to 22, there was at least the fact that equivalent uninflammability and quasi-uninflammability can be achieved by specimens irrespective of various products containing the ammonium polyphosphate having an amount within a range of 40 parts by weight to 75 parts by weight and the phosphoric ester having an amount within a range of 40 parts by weight to 80 parts by weight per 100 parts by weight of the polyol compound.

It is considered, therefore, that a urethane resin composition in an embodiment of the present invention having the ammonium polyphosphate and phosphoric ester whose respective amounts fall within any one of ranges from Range (A) to Range (E) is highly likely to become equivalent to a quasi-uninflammable material, irrespective of any changing of products having such ammonium polyphosphate and phosphoric ester. Further, it is also considered that a urethane resin composition in an embodiment of the present invention having the ammonium polyphosphate and phosphoric ester whose respective amounts fall within any one of ranges from Range (F) to Range (I) is highly likely to become equivalent to an uninflammable material, irrespective of any changing of products having such ammonium polyphosphate and phosphoric ester.

What is claimed is:

1. A urethane resin composition for forming a foam body serving as a thermal insulation material for a building as a result of being sprayed on the building, the urethane resin composition comprising:
a polyisocyanate compound, a polyol compound, a catalyst, a foaming agent, ammonium polyphosphate, and phosphoric ester, the urethane resin composition being free from red phosphorus,
wherein the foaming agent includes water,
wherein the foam body is equivalent to a quasi-uninflammable material defined in a heat release test in conformity with ISO-5660, and
wherein the ammonium polyphosphate and the phosphoric ester are set in amount, respectively, in any one of the following ranges:
range (A) where an amount of the ammonium polyphosphate is 20 parts by weight or more and 75 parts by weight or less, and an amount of the phosphoric ester is 40 parts by weight or more and 80 parts by weight or less, per 100 parts by weight of the polyol compound;
range (B) where an amount of the ammonium polyphosphate is 20 parts by weight or more and 100 parts by weight or less, and an amount of the phosphoric ester is 60 parts by weight or more and 80 parts by weight or less, per 100 parts by weight of the polyol compound;
range (C) where an amount of the ammonium polyphosphate is 40 parts by weight or more and 75 parts by weight or less, and an amount of the phosphoric ester is 40 parts by weight or more and 140 parts by weight or less, per 100 parts by weight of the polyol compound;
range (D) where an amount of the ammonium polyphosphate is 40 parts by weight or more and 100 parts by weight or less, and an amount of the phosphoric ester is 60 parts by weight or more and 140 parts by weight or less, per 100 parts by weight of the polyol compound; and
range (E) where an amount of the ammonium polyphosphate is 40 parts by weight or more and 125 parts by weight or less, and an amount of the phosphoric ester is 140 parts by weight, per 100 parts by weight of the polyol compound.

2. The urethane resin composition according to claim 1, further comprising kaolinite.

3. The urethane resin composition according to claim 2, wherein the kaolinite is fired kaolin.

4. The urethane resin composition according to claim 1, further comprising at least one selected from the group consisting of foam stabilizer, surface conditioner, and compatibilizer.

5. The urethane resin composition according to claim 1, further comprising a trimerization catalyst as the catalyst.

6. A urethane resin composition for forming a foam body serving as a thermal insulation material for a building as a result of being sprayed on the building, the urethane resin composition comprising:
a polyisocyanate compound, a polyol compound, a catalyst, a foaming agent, ammonium polyphosphate, and phosphoric ester, the urethane resin composition being free from red phosphorus,
wherein the foaming agent includes water,
wherein the foam body is equivalent to an uninflammable material defined in a heat release test in conformity with ISO-5660, and
wherein the ammonium polyphosphate and the phosphoric ester are set in amount, respectively, in any one of the following ranges:
range (F) where an amount of the ammonium polyphosphate is 20 parts by weight or more and 75 parts by weight or less, and an amount of the phosphoric ester is 40 parts by weight or more and 80 parts by weight or less, per 100 parts by weight of the polyol compound;
range (G) where an amount of the ammonium polyphosphate is 40 parts by weight or more and 75 parts by weight or less, and an amount of the phosphoric ester is 40 parts by weight or more and 120 parts by weight or less, per 100 parts by weight of the polyol compound;
range (H) where an amount of the ammonium polyphosphate is 40 parts by weight or more and 100 parts by weight or less, and an amount of the phosphoric ester is 60 parts by weight or more and 120 parts by weight or less, per 100 parts by weight of the polyol compound; and
range (I) where an amount of the ammonium polyphosphate is 75 parts by weight or more and 100 parts by weight or less, and an amount of the phosphoric ester is 60 parts by weight or more and 140 parts by weight or less, per 100 parts by weight of the polyol compound.

7. The urethane resin composition according to claim 6, further comprising kaolinite.

8. The urethane resin composition according to claim 7, wherein the kaolinite is fired kaolin.

9. The urethane resin composition according to claim 6, further comprising at least one selected from the group consisting of foam stabilizer, surface conditioner, and compatibilizer.

10. The urethane resin composition according to claim 6, further comprising a trimerization catalyst as the catalyst.
